(19) United States
(12) Patent Application Publication
(10) Pub. No.: US 2025/0151947 A1
(43) Pub. Date: May 15, 2025

(54) Brewed Beverage Maker with Multiple Brewing Adapters

(71) Applicant: Columbia Insurance Company, Omaha, NE (US)

(72) Inventors: Roland Sudmalis, Addison, IL (US); Michael Mastroianni, Addison, IL (US)

(21) Appl. No.: 18/778,916

(22) Filed: Jul. 19, 2024

Related U.S. Application Data
(60) Provisional application No. 63/527,747, filed on Jul. 19, 2023.

(51) Int. Cl. A47J 31/52; A47J 31/34; A47J 31/44

(52) U.S. Cl. CPC A47J 31/52; A47J 31/34; A47J 31/4403

(57) ABSTRACT

A brewed beverage maker is disclosed for use in the creation of a brewed beverage of choice. The brewed beverage maker may have a housing to contain internal components and a water tank for water used in a brewing operation. A lever is actuated from an open position to a closed position to brew the beverage of choice. The brewed beverage maker may have multiple adapters. The multiple adapters are configured to fit within an adapter chamber for operational use. The multiple adapters can be used to brew different types of beverages. In some instances, the adapters are able to accommodate containers designed to hold a specific type of brewing product.

### CROSS-REFERENCE AND PRIORITY CLAIM TO RELATED PATENT APPLICATIONS

This US non-provisional patent application claims priority to U.S. Provisional patent application 63/527,747 filed Jul. 19, 2023, and titled “Brewed Beverage Maker with Multiple Brewing Adapters,” the entire disclosure of which is incorporated herein by reference.

### INTRODUCTION

Brewed beverages have always been a comfort for individuals around the world. Whether it be a steaming cup of tea on a cold raining day, a cup of hot chocolate after attacking the ski slope, or a warm glass of milk to help ease the drinker to sleep, warmed or brewed beverages have a favored place in social culture. Of course, the major leader in many brewed beverage markets is coffee and understandably hot brewed fresh coffee. Coffee is a staple morning, afternoon, and even evening ritual for multiple individuals. Some individuals enjoy a very particular type or preparation style of coffee. Others are simply satisfied with a warm cup to help achieve their needed caffeine boost.

Over the years, brewed beverages including coffee have been prepared in many different forms for consumption. Individual coffee presses have allowed users to create more personal coffee consumption for their needs. Different countries also have developed different methods of brewing and creating this popular warm beverage. Turkish coffee is prepared in a very distinct manner. Other countries and traditions have their own personal way of creating this famous brewed beverage.

Over time, advancements in technology have allowed users to create popular brewed beverages like coffee simply and without much work. The most famous invention in this set and forth method of brewed beverage preparation is of course the common drip coffee or hot beverage brewer. With the quick addition of water and some grounds of one's favorite blend, coffee can be easily created at the push of a button. Drip coffee and drip coffee brewers still have one major drawback. The portion size of the end product cannot be accurately made. A pot of filled water is usually a pot of coffee. Usually, the full pot of coffee is never completely consumed leading to additional waste. Further, not all flavors of coffee or types of coffee related beverages are available with drip coffee brewers. As time moved and continues to move on, the palate of individuals grew and expanded to different brewed beverage tastes.

Recently, innovations in the generally brewed beverage industry introduced the idea of single serving coffee brewers. These coffee brewers use a small serving of coffee grounds contained in a capsule-like product. These single serving coffee brewers became an instant success. First, it eliminated the waste associated with drip coffee brewing techniques and full pots of coffee were no longer needed to be prepared. Individual coffee lovers in homes with less enthusiastic coffee fans could not create the perfect serving for themselves without the waste and of course the necessary clean up. Additionally, these single serving coffee brewers started to offer more choices with their single serving coffee options. More and more flavored coffee choices became available for consumption. While this change did attract more consumers to the single use coffee market, one large limitation loomed over these machines. These single serve machines were almost entirely devoted to coffee type options. Those seeking a stronger brewed beverage such as espresso or those looking for tea or hot chocolate options were generally out of luck. Over time hot chocolate type options appeared, but other types of brewed beverages were still missing from the single serve market.

For smaller volume type beverages such as espresso, large espresso machines have been available for years. These machines are very costly and cater both the high income aficionados of the brewed beverage industry as well as the large coffee shops and chains that specialize in such drinks. Eventually, the single serve coffee market was also to offer a type of single serve espresso type beverage. But that too had its drawbacks.

As the single serve coffee maker and brewed beverage maker market grew, many companies realized that the size and shape of the container used to hold the grounds to create the brewed beverage was key to market success. While the general size and shape of the coffee related container had been semi-standardized, container design for other types of brewed beverages had not. Thus, when the first espresso related single serve machine entered the marketplace, the serving container of the concoction used to create the serving of espresso type beverages employed a different design. Thus, the espresso type serving containers would not be compatible with a customer's current owned single serve coffee maker. To have access to the single serve espresso type offering, the consumer was forced to purchase a second machine created to house the serving container offering the espresso type product. This of course led to large profits for those companies offering these types of new machines and also different nonstandard container sizes. Much to the customer's dismay.

As the market grew, more and more companies began to offer their own type of coffee or brewed beverage type containers designed for use only within a company machine. Thus, the market of the single use brewed beverage maker was flooded with multiple types of offerings. It soon became common that a coffee fan's favorite brew could only be made on a certain type of machine as it was contained in a specific container configuration for use with that machine. The idea of owning one machine, like was standard before the single serve brewed beverage market came into existence, now required the customer to have two or more machines just to have a general range of brewed beverage offerings available. Moreover, general consumer backlash started against these companies due to the large environmental footprint and waste with these containers as they are discarded after each use. While some returned to traditional coffee grounds in newly designed contraptions used to fit the owner's current single serve coffee machine, customers as of today are still limited by the capabilities of the machine they currently own and what type of container design is needed to fit said machine.

The inventors envision such a new type of brewed beverage maker which can solve and address these issues in the industry and complaints of the customer. The brewed beverage maker disclosed by the inventors not only can brew beverages for a certain type of container used in certain machines, but the envisioned brewed beverage maker can also contain a plurality of adaptors that can easily be interchanged. The plurality of adaptors used by the envisioned brewed beverage maker created by the inventors can not only offer multiple different types of brewed beverage options, but the plurality of adaptors can also fit and contain a multitude of different design types of containers developed and sold on the market for use with single use brewing machines. Thus, the envisioned and disclosed brewed beverage maker greatly increases the customers options available on the types of brewed beverages that can be created by the disclosed brewed beverage maker and also increases the number of offerings available to the customer by expanding the type of containers that can be used with the brewed beverage maker to create a brewed beverage offering.

Further features and advantages of the disclosed embodiments, as well as the structure and operation of various elements of the disclosed embodiments, are described in detail below with reference to the accompanying drawings.

### BRIEF DESCRIPTION OF THE DRAWINGS

The accompanying drawings, which are incorporated in and form a part of the specification, illustrate the disclosed embodiments and, together with the description, serve to explain certain inventive principles. In the drawings:

FIG. 1 illustrates an angled perspective view of the brewed beverage maker with brewing adapters in accordance with an embodiment of the disclosure.

FIG. 2 illustrates a front view of the brewed beverage maker with brewing adapters in accordance with an embodiment of the disclosure.

FIG. 3 illustrates a back view of the brewed beverage maker with brewing adapters in accordance with an embodiment of the disclosure.

FIG. 4 illustrates a first side view of the brewed beverage maker with brewing adapters with a door in a closed position in accordance with an embodiment of the disclosure.

FIG. 5 illustrates a first side view of the brewed beverage maker with brewing adapters with a door in an open position in accordance with an embodiment of the disclosure.

FIG. 6 shows a top view of the brewed beverage maker with brewing adapters in accordance with an embodiment of the disclosure.

FIG. 7 shows a second side view of the brewed beverage maker with brewing adapters in accordance with an embodiment of the disclosure.

FIG. 8 shows an alternate perspective second side view of the brewed beverage maker with multiple brewing adapters with a water tank is removed from the brewed beverage maker in accordance with an embodiment of the disclosure.

FIG. 9A shows a back tilting view of the water tank usable with the brewed beverage maker in accordance with an embodiment of the disclosure.

FIG. 9B shows a cross-sectional view of the water tank along a first axis in accordance with an embodiment of the disclosure.

FIG. 9C shows another cross-sectional view of the water tank along a second axis in accordance with an embodiment of the disclosure.

FIG. 10A shows a front perspective view of the internal operational components used with the brewed beverage maker without the housing of the brewed beverage maker in accordance with an embodiment of the disclosure.

FIG. 10B shows a back view of the internal operational components used with the brewed beverage maker without the housing of the brewed beverage maker in accordance with an embodiment of the disclosure.

FIG. 11 shows a back tilting perspective view of the brewed beverage maker without an adapter within the adapter chamber in accordance with an embodiment of the disclosure.

FIG. 12A shows a perspective view of a coffee pod adapter usable with the brewed beverage maker in accordance with an embodiment of the disclosure.

FIG. 12B shows a top down perspective view of a coffee pod adapter, without a coffee pod, and with an open lid, that may be usable with the brewed beverage maker in accordance with an embodiment of the disclosure.

FIG. 12C shows a bottom view of a coffee pod adapter usable with the brewed beverage maker in accordance with an embodiment of the disclosure.

FIG. 12D shows a back view of a coffee pod adapter usable with the brewed beverage maker in accordance with an embodiment of the disclosure.

FIG. 12E shows a cross sectional side view of a coffee pod adapter usable with the brewed beverage maker in accordance with an embodiment of the disclosure.

FIG. 12F shows an exploded view of components used in a coffee pod adapter that may be used with the brewed beverage maker in accordance with an embodiment of the disclosure.

FIG. 13A shows a side view of a flow director usable with the coffee pod adapter that may be used with the brewed beverage maker in accordance with an embodiment of the disclosure.

FIG. 13B shows a cross sectional side view of a flow director usable with the coffee pod adapter that may be used with the brewed beverage maker in accordance with an embodiment of the disclosure.

FIG. 13C shows a top down view of a flow director usable with the coffee pod adapter that may be used with the brewed beverage maker in accordance with an embodiment of the disclosure.

FIG. 14A shows a perspective view of an espresso pod adapter usable with the brewed beverage maker in accordance with an embodiment of the disclosure.

FIG. 14B shows a top down perspective view of an espresso pod adapter, without an espresso pod, and with an open lid, that may be usable with the brewed beverage maker in accordance with an embodiment of the disclosure.

FIG. 14C shows a bottom view of an espresso pod adapter usable with the brewed beverage maker in accordance with an embodiment of the disclosure.

FIG. 14D shows a back view of an espresso pod adapter usable with the brewed beverage maker in accordance with an embodiment of the disclosure.

FIG. 14E shows a cross sectional side view of an espresso pod adapter usable with the brewed beverage maker in accordance with an embodiment of the disclosure.

FIG. 14F shows an exploded view of components used in an espresso pod adapter that may be used with the brewed beverage maker in accordance with an embodiment of the disclosure.

FIG. 15A shows a perspective view of a hot water adapter usable with the brewed beverage maker in accordance with an embodiment of the disclosure.

FIG. 15B shows a top down view of a hot water adapter that may be usable with the brewed beverage maker in accordance with an embodiment of the disclosure.

FIG. 15C shows a bottom view of a hot water adapter usable with the brewed beverage maker in accordance with an embodiment of the disclosure.

FIG. 15D shows a back view of a hot water adapter usable with the brewed beverage maker in accordance with an embodiment of the disclosure.

FIG. 15E shows exploded view of components used in a hot water adapter usable with the brewed beverage maker in accordance with an embodiment of the disclosure.

FIG. 16A shows a perspective view of a ground espresso adapter usable with the brewed beverage maker in accordance with an embodiment of the disclosure.

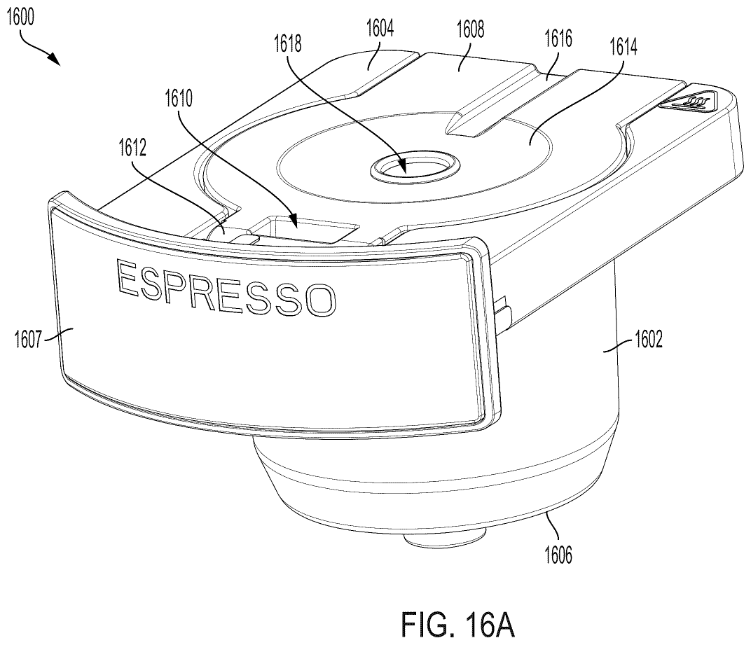

FIG. 16B shows a top down perspective view of a ground espresso adapter, having an open lid, alongside an espresso container that may be usable with the brewed beverage maker in accordance with an embodiment of the disclosure.

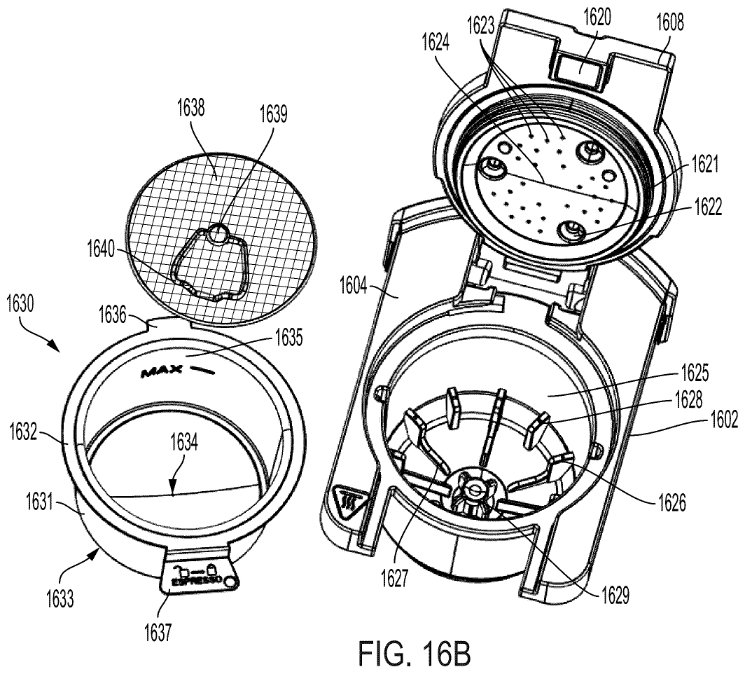

FIG. 16C shows a bottom view of a ground espresso adapter usable with the brewed beverage maker in accordance with an embodiment of the disclosure.

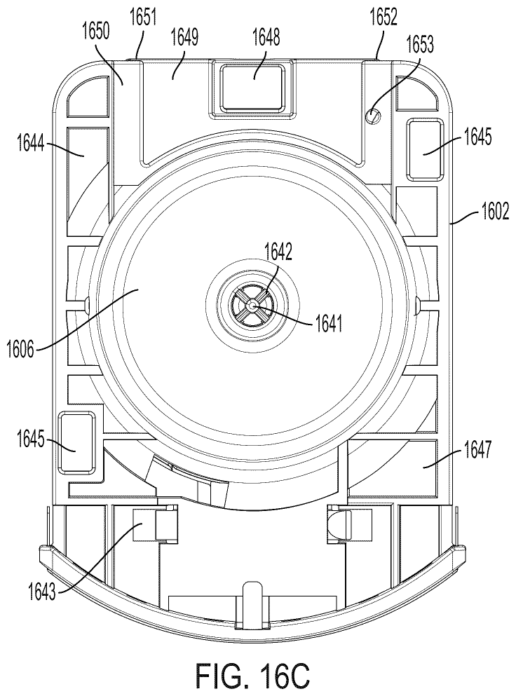

FIG. 16D shows a back view of a ground espresso adapter usable with the brewed beverage maker in accordance with an embodiment of the disclosure.

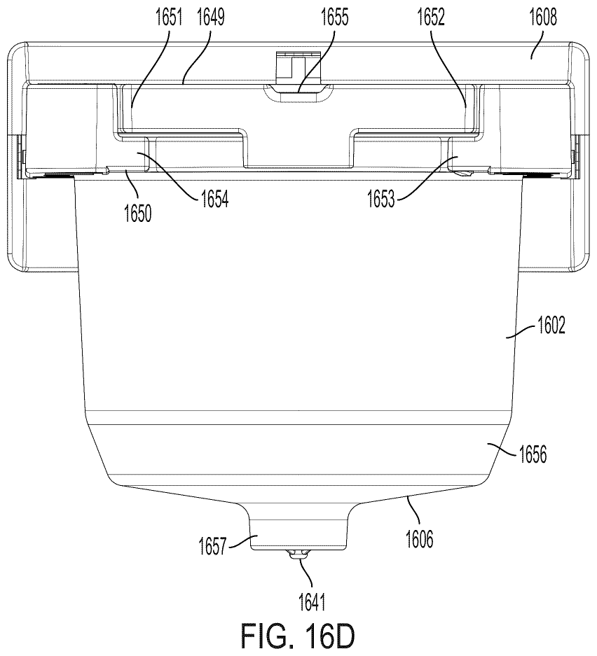

FIG. 16E shows a cross sectional side view of a ground espresso adapter usable with the brewed beverage maker in accordance with an embodiment of the disclosure.

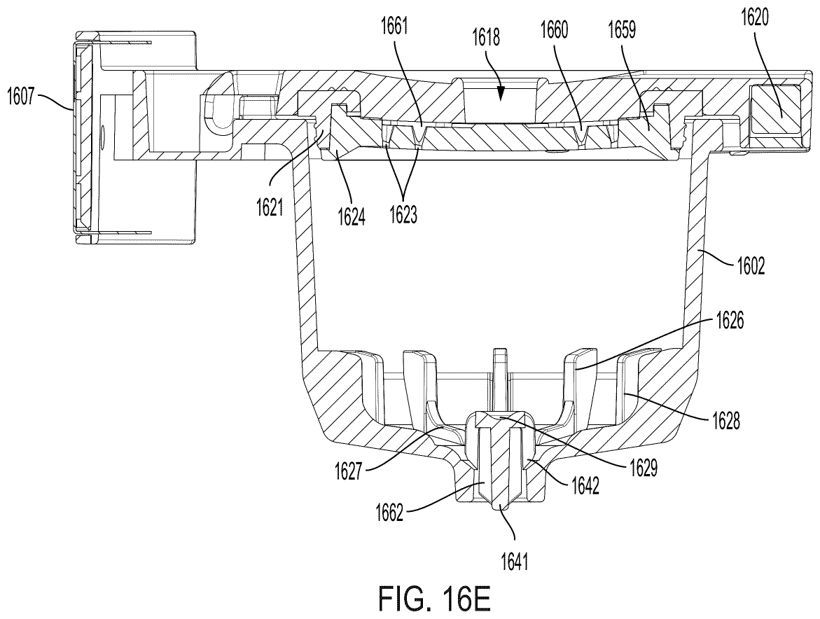

FIG. 16F shows an exploded view of components used in a ground espresso adapter that may be used with the brewed beverage maker in accordance with an embodiment of the disclosure.

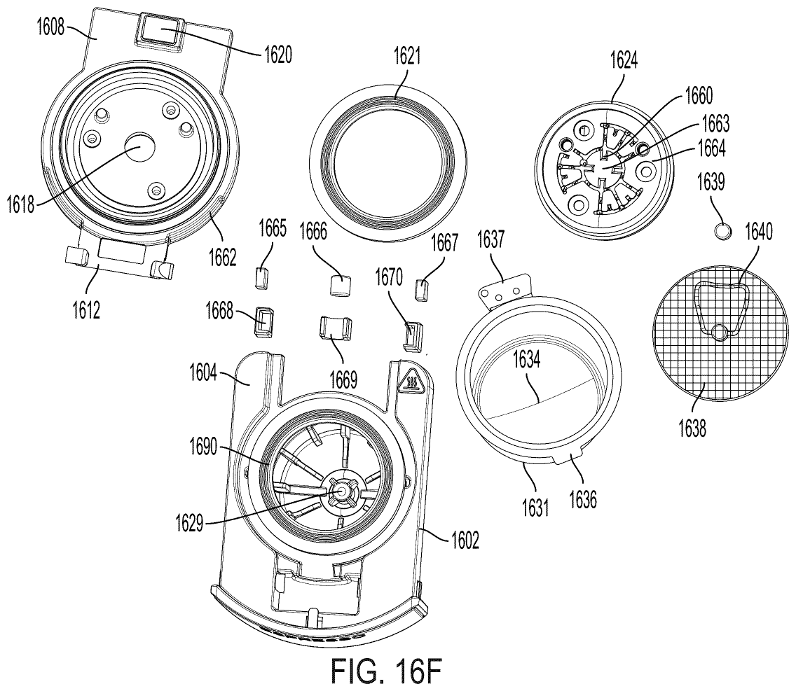

FIG. 17A shows a perspective view of a ground coffee adapter usable with the brewed beverage maker in accordance with an embodiment of the disclosure.

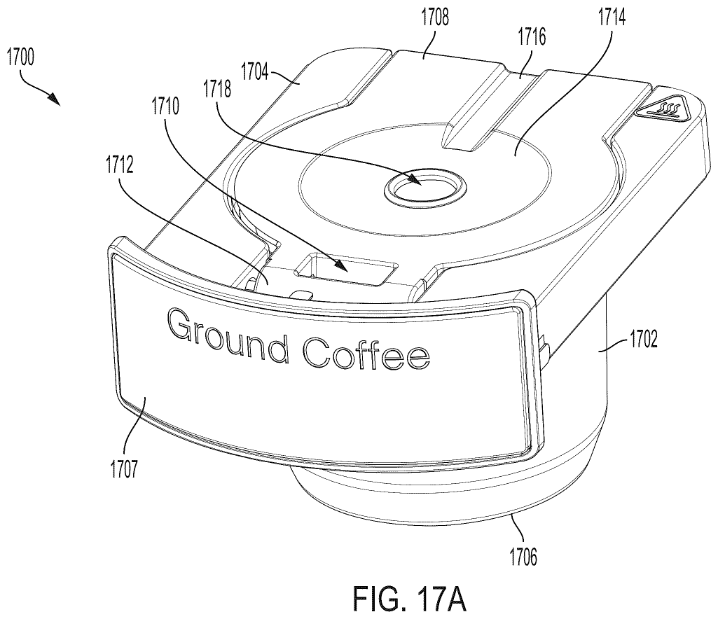

FIG. 17B shows a top down perspective view of a ground coffee adapter, having an open lid, alongside a coffee container that may be usable with the brewed beverage maker in accordance with an embodiment of the disclosure.

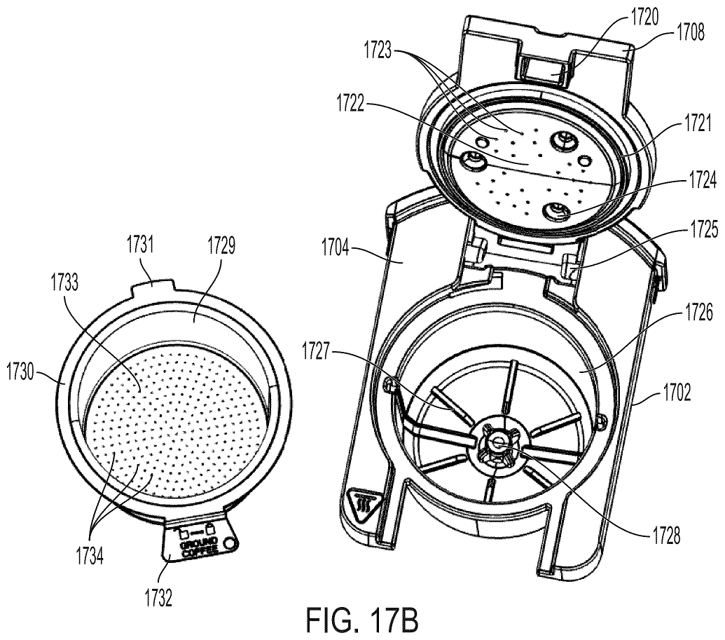

FIG. 17C shows a bottom view of a ground coffee adapter usable with the brewed beverage maker in accordance with an embodiment of the disclosure.

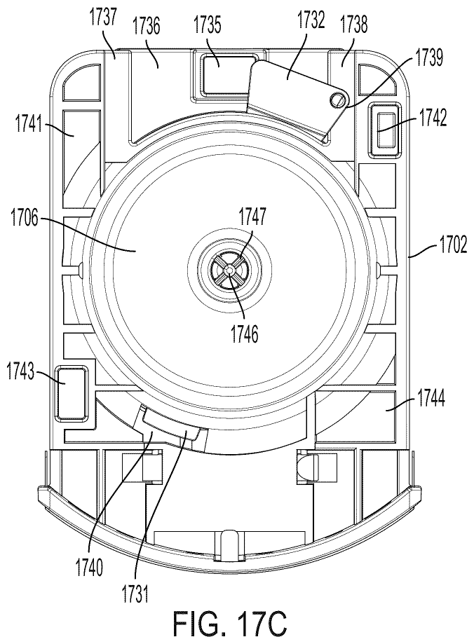

FIG. 17D shows a back view of a ground coffee adapter usable with the brewed beverage maker in accordance with an embodiment of the disclosure.

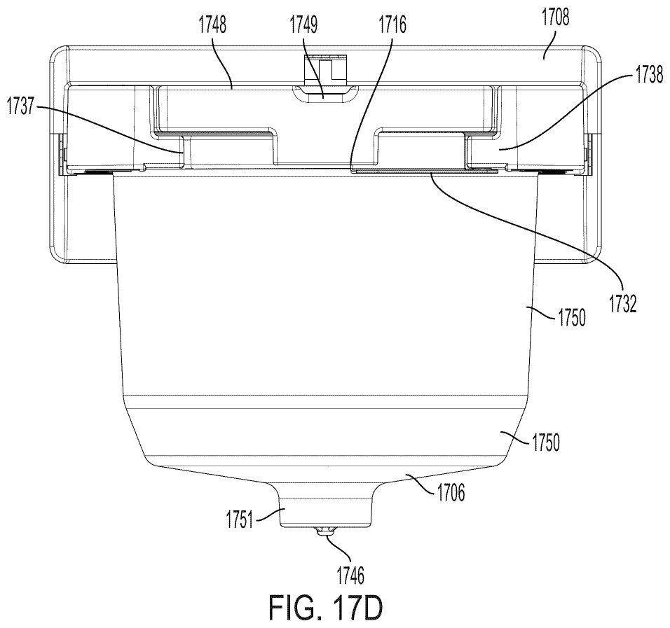

FIG. 17E shows a cross sectional side view of a ground coffee adapter usable with the brewed beverage maker in accordance with an embodiment of the disclosure.

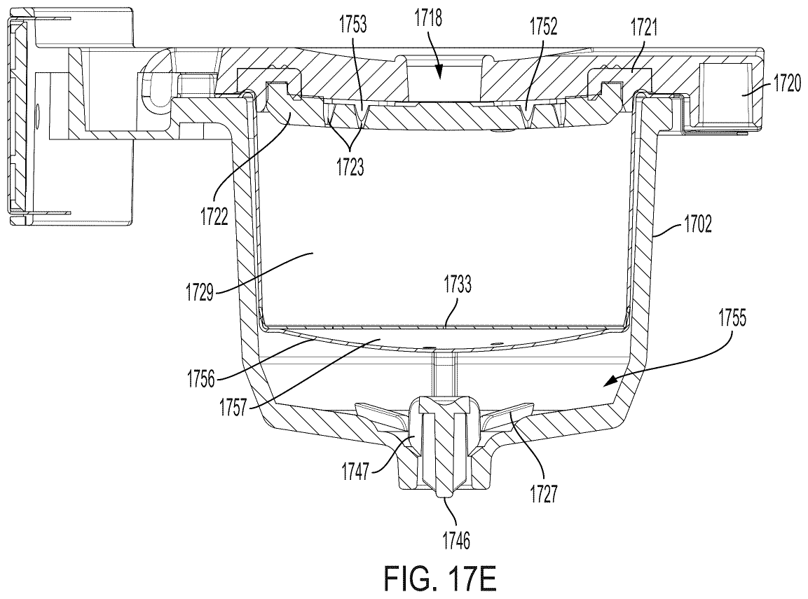

FIG. 17F shows an exploded view of components used in a ground coffee adapter that may be used with the brewed beverage maker in accordance with an embodiment of the disclosure.

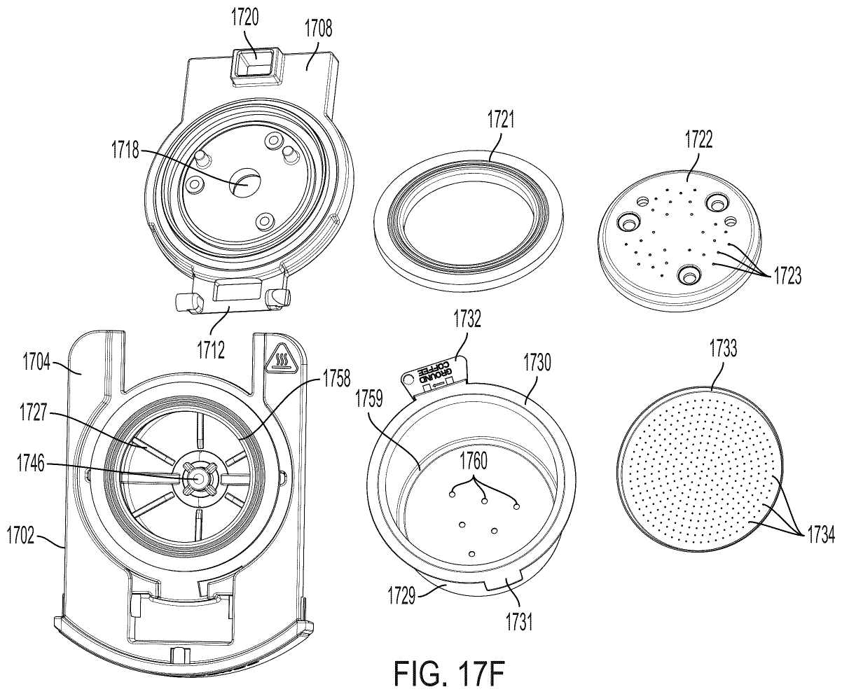

FIG. 18 shows a front vide of a user interface of a control panel usable with the brewed beverage maker in accordance with an embodiment of the disclosure.

FIG. 19 illustrates a flowchart detailing high altitude operation possible with the brewed beverage maker in accordance with an embodiment of the disclosure.

FIG. 20 illustrates a flowchart detailing a pause and a resume operation possible with the brewed beverage maker in accordance with an embodiment of the disclosure.

FIG. 21 illustrates a flowchart detailing a cancel operation possible with the brewed beverage maker in accordance with an embodiment of the disclosure.

FIG. 22 illustrates a flowchart detailing a startup operation possible with the brewed beverage maker in accordance with an embodiment of the disclosure.

FIG. 23A illustrates a flowchart detailing a descaling operation possible with the brewed beverage maker in accordance with an embodiment of the disclosure.

FIG. 23B illustrates a flowchart that continues to detail the descaling operation possible with the brewed beverage maker in accordance with an embodiment of the disclosure.

FIG. 24A illustrates a flowchart detailing an example brewing operation when an espresso pod adapter is used with the brewed beverage maker to create a brewed beverage in accordance with an embodiment of the disclosure.

FIG. 24B illustrates a flowchart that continues to detail the example brewing operation when the espresso pod adapter is used with the brewed beverage maker to create a brewed beverage in accordance with an embodiment of the disclosure.

FIG. 24C illustrates a flowchart that continues to detail the example brewing operation when the espresso pod adapter is used with the brewed beverage maker to create a brewed beverage in accordance with an embodiment of the disclosure.

FIG. 25A illustrates a flowchart detailing an example brewing operation when a ground espresso adapter is used with the brewed beverage maker to create a brewed beverage in accordance with an embodiment of the disclosure.

FIG. 25B illustrates a flowchart that continues to detail the example brewing operation when the ground espresso adapter is used with the brewed beverage maker to create a brewed beverage in accordance with an embodiment of the disclosure.

FIG. 25C illustrates a flowchart that continues to detail the example brewing operation when the ground espresso adapter is used with the brewed beverage maker to create a brewed beverage in accordance with an embodiment of the disclosure.

FIG. 26A illustrates a flowchart detailing an example brewing operation when a coffee pod adapter is used with the brewed beverage maker to create a brewed beverage in accordance with an embodiment of the disclosure.

FIG. 26B illustrates a flowchart that continues to detail the example brewing operation when the coffee pod adapter is used with the brewed beverage maker to create a brewed beverage in accordance with an embodiment of the disclosure.

FIG. 26C illustrates a flowchart that continues to detail the example brewing operation when the coffee pod adapter is used with the brewed beverage maker to create a brewed beverage in accordance with an embodiment of the disclosure.

FIG. 27A illustrates a flowchart detailing an example brewing operation when a hot water adapter is used with the brewed beverage maker to create a brewed beverage in accordance with an embodiment of the disclosure.

FIG. 27B illustrates a flowchart that continues to detail the example brewing operation when the hot water adapter is used with the brewed beverage maker to create a brewed beverage in accordance with an embodiment of the disclosure.

FIG. 27C illustrates a flowchart that continues to detail the example brewing operation when the hot water adapter is used with the brewed beverage maker to create a brewed beverage in accordance with an embodiment of the disclosure.

FIG. 27D illustrates a flowchart that continues to detail the example brewing operation when the hot water adapter is used with the brewed beverage maker to create a brewed beverage in accordance with an embodiment of the disclosure.

FIG. 28A illustrates a flowchart detailing an example brewing operation when a ground coffee adapter is used with the brewed beverage maker to create a brewed beverage in accordance with an embodiment of the disclosure.

FIG. 28B illustrates a flowchart that continues to detail the example brewing operation when the ground coffee adapter is used with the brewed beverage maker to create a brewed beverage in accordance with an embodiment of the disclosure.

FIG. 28C illustrates a flowchart that continues to detail the example brewing operation when the ground coffee adapter is used with the brewed beverage maker to create a brewed beverage in accordance with an embodiment of the disclosure.

### DETAILED DESCRIPTION OF EXAMPLE EMBODIMENTS

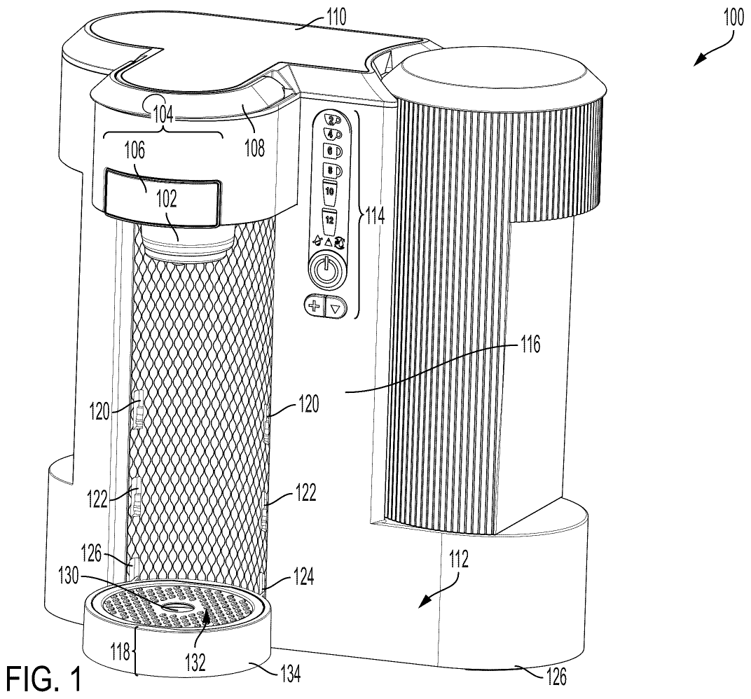

Referring to the accompanying drawings, FIG. 1 illustrates an angled perspective view of the example brewed beverage maker 100 with brewing adapters. The brewed beverage maker viewed in FIG. 1 is shown from a top-down angle from the right side. The brewed beverage maker may have a front side, a back side, a first side, a second side, a top side, and a bottom side. The brewed beverage maker viewed in FIG. 1 is in an operational state and ready to brew a desired beverage. An adapter 102 of a plurality of adapters is present within the adapter chamber 104 of the brewed beverage maker. While the exact adapter viewed in FIG. 1 in generically illustated, it should be understood to be an an adapter like those disclosed herein (a coffee pod adapter, a espresso pod adapter, a hot water adapter, a ground coffee adapter, or a ground espresso adapter), or any other type of adapter that can possible brew or create a beverage of any temperature. In operational use, the front plate 106 attached to the front side of the adapter will communicate to the user the exact function of the adapter and its proposed use to create and brew a particular beverage. Additionally, it is envisioned by the inventors that additional adapters, such as tea, coca, mate, or others or the like can be used with the example brewed beverage maker including adapter for use brewing cold beverages. These additional adapters may be configured to accept and use certain designs of containers, commonly known as pods or capsules, containing a brewing product to create the beverage. These pods or capsules may or may not contain coffee or espresso as the brewing product. Both pods and capsules current offered in different container configurations are envisoned to be used with the brewed beverage maker as well as future adaptations of current market designs. Further, these additional adapters may be envisioned to brew additional beverage products that may require a more unique or specific adapter design.

In FIG. 1, the brewed beverage maker 100 is also known to be in an operational state and ready to brew a desired beverage as the lever 108 used to secure the adapter in place within the adapter chamber is in the closed position. The lever is located between and may be in alignment with a top housing area 110 of a housing 112 of the brewed beverage maker 100. The lever 108, in the closed position, may also be in general alignment with an adapter housing area above the adapter chamber that contains the internal lever actuation components and output nozzle of the brewed beverage maker. The lever 108 can move between an open position where it is not in contact with the other components of the housing 112 and appears angled above the top of the housing 112 of the brewed beverage maker, to a closed position where the lever 108 is in contact with the other components of the housing 112 and appears to be part of the continuous housing 112 of the brewed beverage maker. In the open position, the lever retracts an insertable needle that can move in an up and down motion. The open position may also retract a sealing member contained within the adapter housing area. The closed position expends the sealing member into the adapter chamber to press against and seal a connection to the selected adapter when a brewing operation is desired. In some embodiments, the open position of the lever will further assist to eject the adapter it used for a brewing operation or by mistaken selection by the end user. The open position of the lever 108 may assist to move the adapter's position within the adapter chamber below the lever. When in the open position the needle of the brewed beverage maker is fully retracted and cannot be accessed by the user of the brewed beverage maker. The needle and the sealing member may each expand into the adapter chamber and retract into the adapter housing area as a single operational unit. Retracting the needle is done mainly for safety reasons when the lever 108 is in the open lever position. This is done so a user cannot be harmed by erroneously contacting the needle. Further, the needle is aided to remain in a covered inaccessible position up within the adapter housing area above the adapter chamber with the aid of a spring that keeps the needle from moving downward without the user actuating the lever 108 to the closed position.

When the lever 108 is moved from the open position to the closed position the lever causes the actuation components contained within the adapter housing area above the adapter chamber to operate and move. Movement of the lever 108 to the closed position moves the actuation components so that the needle is moved downward and inserted into a respective opening on a top surface of the adapter chamber and further inserted into the adapter 102 within the adapter chamber 104. If no adapter is present within the adapter chamber the lever may not move from the open position to the closed position. A controller, that may be located on a printed circuit board within the housing 112, may detect the presence of an adapter 102 within the adapter chamber 104. If no adapter is present, the controller may lock and prohibit movement of the lever 108 from the open position to the closed position. In other instances, if no adapter is placed within the adapter chamber, the lever may simply move from the open position to the closed position but will not remain within the closed position.

If an adapter 102 is correctly placed within the adapter chamber 104, and the controller recognizes the presence of the adapter, the lever 108 may move from the open position to the closed position where it locks the adapter 102 into place for a possible brewing operation. Moving the lever from the open position to the closed position moves the needle above opening of the top surface of the adapter chamber 104 into the selected adapter 102 and through any opening within the adapter 102. In some example embodiments, the needle may puncture a container housed within the adapter 102 to brew the beverage. While the needle actuates in the downward direction with movement of the lever 108 from the open position to the closed position, the sealing member located movably between the adapter chamber 104 aand the adapter housing area near the needle may also move in the downward direction into the adapter chamber 104. The sealing member may make contact and form tight contact with the adapter 102 to prepare the beverage possible with use of the chosen adapter 102. When the controller confirms that an adapter 102 is correctly positioned in the adapter chamber 104 and that the needle and the sealing member have properly engaged and secured the adapter for a correct brewing operation, the controller can signal the control panel 114 on the front face of the housing 112 to provide select brewing options to the user. The brewing options available to the user will be based on the programming of the controller as well as the adapter 102 selected by the user for the brewing operation. For example, a coffee adapter may have additional brewing distribution options available as possible choices for a brewed portion size of the brewed beverage\compared to using an espresso adapter. Such choices for the brewed portion sizes is dependent on both the adapter 102 selected by the user and logic circuitry programmed within the controller internally housed in the brewed beverage maker 100.

Below the adapter 102 housed in the adapter chamber 104, a drip tray 118 may can be present. The drip tray 118 can be adjustable by the user to accommodate the size of the container, cup, or vessel, selected by the user that is to contain the brewed beverage from the brewed beverage maker 100. The drip tray 118 may be movable between a plurality of placement positions. A first placement position 120 may be nearest to the adapter 102 within the adapter chamber 104. A second placement position 124 may be near a base 126 of the brewed beverage maker 100. A third placement position 122 may be between the first placement position 120 and the second placement position 124. A drip tray aligner 128 may extend outward from the base 126 of the housing 112 to accommodate the drip tray 118 in the lowest position which may be the second placement position 124. Here, the drip tray 118 may mate with and be in removable attachment with to the drip tray aligner 128. The co drip tray 118 may be secured to position on the front housing 116 by a plurality of hooks positioned to fit within a plurality of hook slots present on the front housing 116 of the brewed beverage maker 100. In other additional embodiments, the drip tray 118 may be envisioned to be slidable up and down a drip tray channel forming part of the front housing 116 of the brewed beverage maker 100. The drip tray channel may indent into the front housing 116 of the brewed beverage maker 100 to accommodate the circular form of drip tray 118. Further, in this movable embodiment the drip tray 118 may locationally slide up and down within the drip tray channel in alignment with drip tray aligner 128 to accommodate more than three possible locations for a container to sit upon the drip tray 118 when receiving a brewed beverage.

The drip tray 118 may be formed by multiple components. The drip tray 118 may have an insert 130 with a plurality of openings 132. The insert 130 may rests upon the generally circular design of the drip tray 118 in a top recessed edge. The lower part of the drip tray 118 may be a catch location 134 where liquid or debris passing through one or more of the plurality of openings 132 can be contained. Thus, a brewed beverage that either overflows the container or adapter drippings during or after operational use can first contact the insert 130 with a plurality of openings 132, and may then through the plurality of openings 132 down to the catch location 134 of the drip tray 118 for collection. As the drip tray 118 is removably attached to the front housing 116, the drip tray 118 can be removed. The insert 130 can also be removed from its placement within drip tray 118. Both may be made of dishwasher safe materials so they can easily be cleaned after operational use.

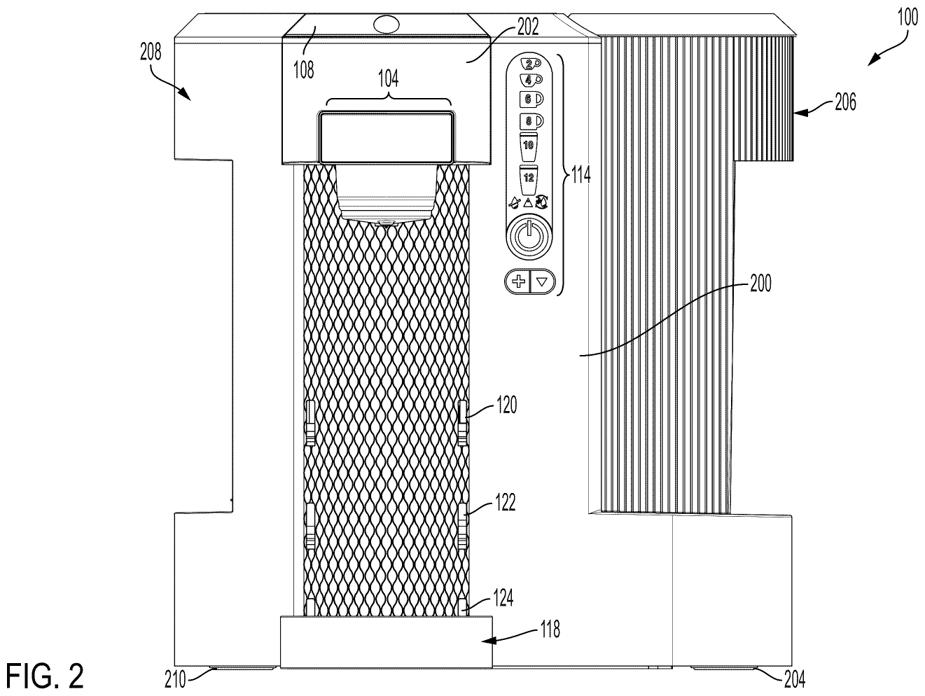

Turning now to FIG. 2, a front view of the example brewed beverage maker 100 with brewing adapters is shown. The front of the brewed beverage maker 100 may consist of a front housing 112 that secures and contains multiple operational components of the brewed beverage maker 100. As discussed above, the drip tray aligner 128, the drip tray 118, the adapter 102 located within the adapter chamber 104, the actuation housing 202 above the adaptor chamber 104, and the lever 108 are all present. The lever 108 in FIG. 2 is also viewed in the closed or operational position.

On the right side of FIG. 2, the front housing 116 of the brewed beverage maker 100 is a barrier protecting and containing the internal operational components needed to operate the brewed beverage maker 100. At the bottom of the right side below the housing 112 of the brewed beverage maker a first surface grip 204 of a plurality of surface grips may be viewed and present. The first surface grip 204 of a plurality of surface grips can contact the surface upon which the brewed beverage maker 100 rests and provide a large amount of frictional force so that a gentle effort or accidentally contact with the brewed beverage maker 100 will not cause it to move or topple. Above the housing 112 of the brewed beverage maker 100 on the right side a water tank 206 is present. The water tank 206 is to be filled by the user, and the water contained within the water tank 206 flows through the internal components behind the housing 112 to create the brewed beverage of choice during operation of the brewed beverage maker 100.

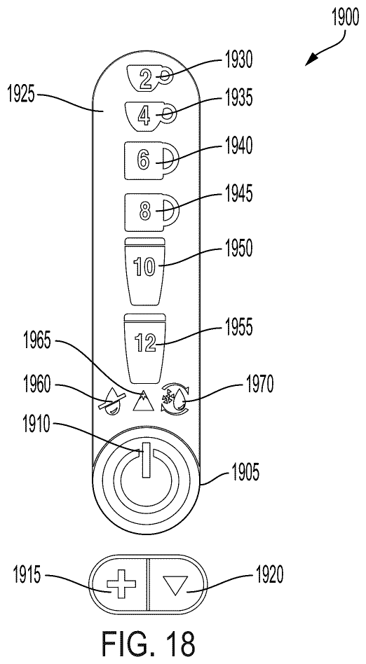

In the middle of the brewed beverage maker 100, to the right of the adapter chamber 104, a control panel 114 may be present. The control panel 114 may have a dedicated printed circuit board with a user interface and action button. Further information and features associated with the control panel and user interface facing the user will be explained later in reference to FIG. 18.

On the left side of the front view of the brewed beverage maker 100, the adapter storage 208 is present. As viewed on the far-left side, a door is present that can open and close the adapter housing area. If a new adapter is needed, the door may be opened to select and remove the adapter of choice. The old adapter previously attached within the adapter chamber can then be placed within the adapter housing to remain until further use of that particular adapter is desired by the user. At the bottom of the left side, below the adapter housing 208 of the brewed beverage maker 100, a second surface grip 210 of the plurality of surface grips may be present. The second surface grip 210 can contact the surface upon which the brewed beverage maker 100 rests and provides a sufficient amount of frictional force so that accidental movement or hitting of the brewed beverage maker 100 will not cause it to move.

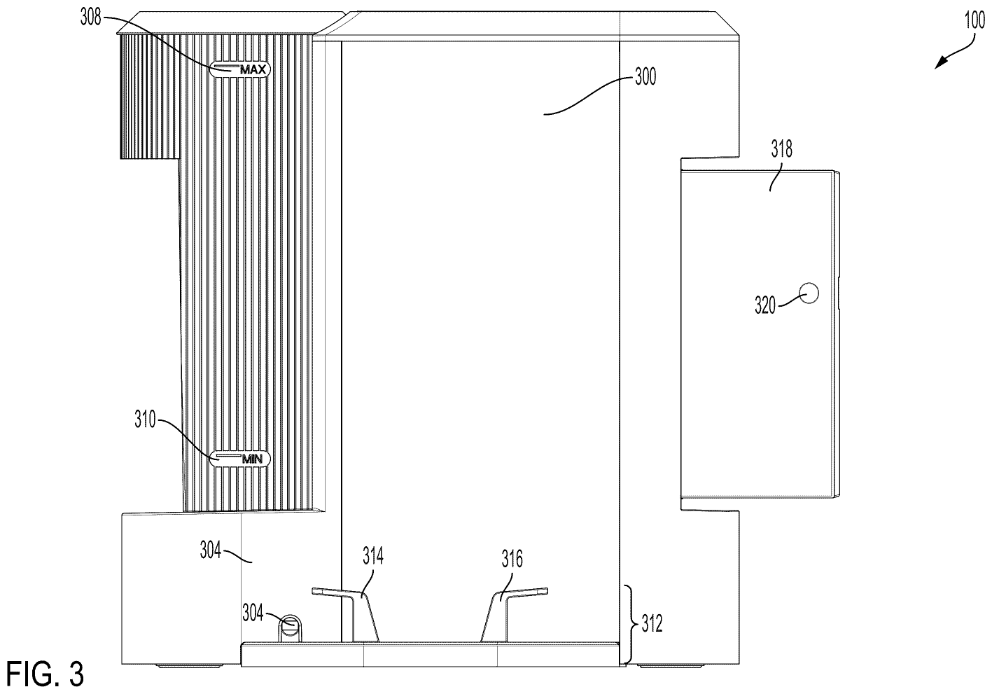

In FIG. 3, a back view of the example brewed beverage maker 100 with brewing adapters is visible. Mainly viewable in FIG. 3 is the back housing 300 of the brewed beverage maker 100. The back housing 300 provides a barrier that protects and contains the internal operational components. On the left side of FIG. 3, a lower portion of the back housing 300 is viewed. The lower portion of the back side of the housing may have a power cord opening 304. The power cord opening 304 may house a power cord that is connected internally to the power supply of the brewed beverage maker 100 to operate the brewed beverage maker 100. The power cord can then exit the interior of the housing 112 through the power cord opening 304 for attachment to an appropriate power source for operational use by the user of the brewed beverage maker 100. Above the housing on the left side of the back housing 300, the water tank 206 is viewed again. As stated above, the water tank 206 holds water for use with the brewed beverage maker 100 to make a beverage. The water tank 206 in this view contains a plurality of water volume symbols. A max symbol 308 is located near the top of the water tank 206 indicating the highest amount of water for operational use of the brewed beverage maker 100. Near the bottom of the water tank 206, a min symbol 310 is present. The min symbol 310 indicates the lowest possible water level for use of the brewed beverage maker 100. At or below this min symbol 310, an LED indicating low water levels may illuminate on the brewed beverage maker 100 and the brewed beverage maker 100 may cease operational functions until water is added to the water tank 206.

In the middle of the back view of the brewed beverage maker 100, the rear panels of the back housing 300 are generally present. However, at the lower portion of the middle area a cord storage location 312 is present. The cord storage location 312 is located behind the brewed beverage maker 100. A power cord exiting from the power cord opening 304 can wrap around each the left angled power cord wrap 314 and the right-angled power cord wrap 316 to secure the power cord to the overall design of cord storage location 312 when the brewed beverage maker 100 is not in use. Further, the cord storage location 312 extends outward away from the back housing 300 of the brewed beverage maker 100. The cord storage location 312 at the rear portion, like the drip tray aligner 128 of the front portion, helps balance and positionally secure the the brewed beverage maker 100 into place on the surface so that it does not accidentally tip or topple if contacted.

Finally, on the right side of FIG. 3 the adapter storage 208 is present. As viewed on the right side, a door 318 is present that can open and close access to the adapter storage 208. If a new adapter is needed, the door 318 may be opened to select and remove the adapter of choice. A grip 320, or knob, may be present on the door 318 to open and close the door to the adapter storage 208 as needed. A previously used adapter 102 can be removed from within the adapter chamber 104 can then be placed within the adapter storage 208 to remain until further use of that particular adapter is needed.

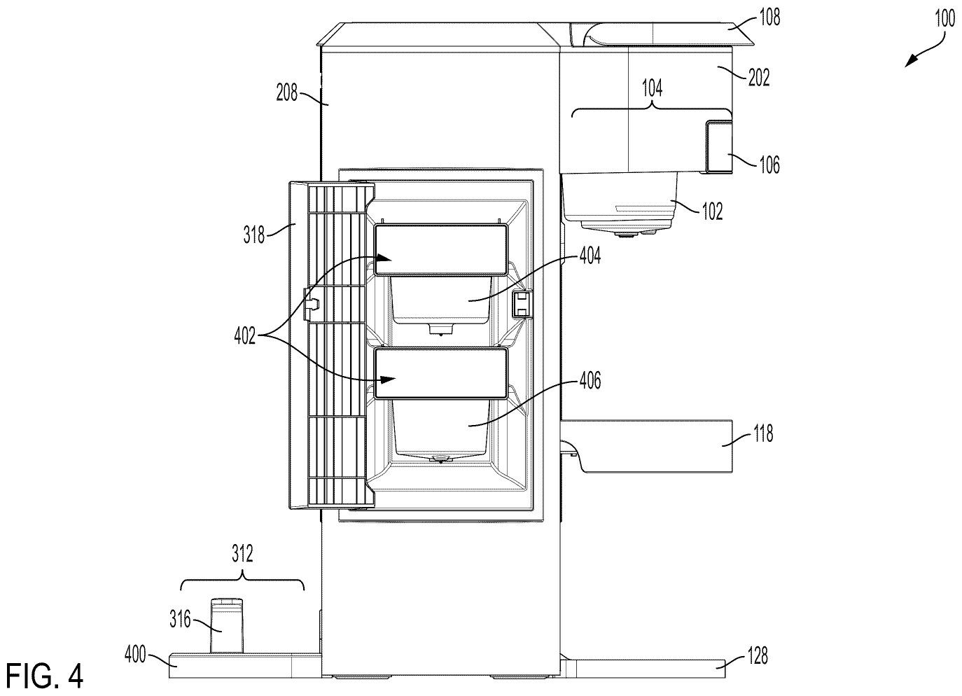

Next, in FIG. 4 is a first side view is shown of the example brewed beverage maker 100 with brewing adapters. On the left side of FIG. 4, the cord storage location 312 is viewed. The cord storage location 312 is discussed above with respect to FIG. 3. The view in FIG. 4 does provide a better perspective of how the cord storage location 312, through use of a cord storage extension 400, helps balance and secure the brewed beverage maker 100 from tipping over and falling. As can be understood in FIG. 4, the width of the brewed beverage maker 100 is rather small with a larger height and length. Thus, the cord storage extension 400 outward to the rear of the brewed beverage maker, and its connection to the housing 112 of the brewed beverage maker 100 helps from tipping and falling.

On the right side of FIG. 4, the components discussed with FIG. 1 are present again. Here, the lever 108 is viewed in the closed or operational position at the top of the brewed beverage maker 100. Below the lever, the adapter housing area for the actuator components and nozzle is present. Below the adapter housing area, an adapter 102 is viewed positioned within the adapter chamber 104 and ready for use. Underneath the adapter 102, the drip tray 118 is present. Finally, under the drip tray 118, the drip tray aligner 128 is viewed attached to the base of the brewed beverage maker 100. The view in FIG. 4 provides a better perspective of how the drip tray aligner 128 helps balance and secure the brewed beverage maker 100 from tipping over and falling. As can be understood in FIG. 4, the width of the brewed beverage maker is smaller than its length and height. Thus, the cord storage extension 400 and the drip tray aligner 128 with the base of the brewed beverage maker 100 helps it from tipping over and falling.

In the middle portion of FIG. 4, the adapter storage 208 is viewed. The door 318 to the adapter storage 208 is view as open. When it is closed, the door 318 mates with the remainder of the adapter storage 208 design to create a smooth continuous appearance. The door can be opened by the grip 320, or knob, viewed in FIG. 3. As viewed in FIG. 4, a plurality of adapters 402 are located within the adapter storage 208. A first adapter 404 is located aboved a second adapter 406. Each the first adapter 404 and the second adapter 406 are in stored parallel to one another within the adapter storage 208.

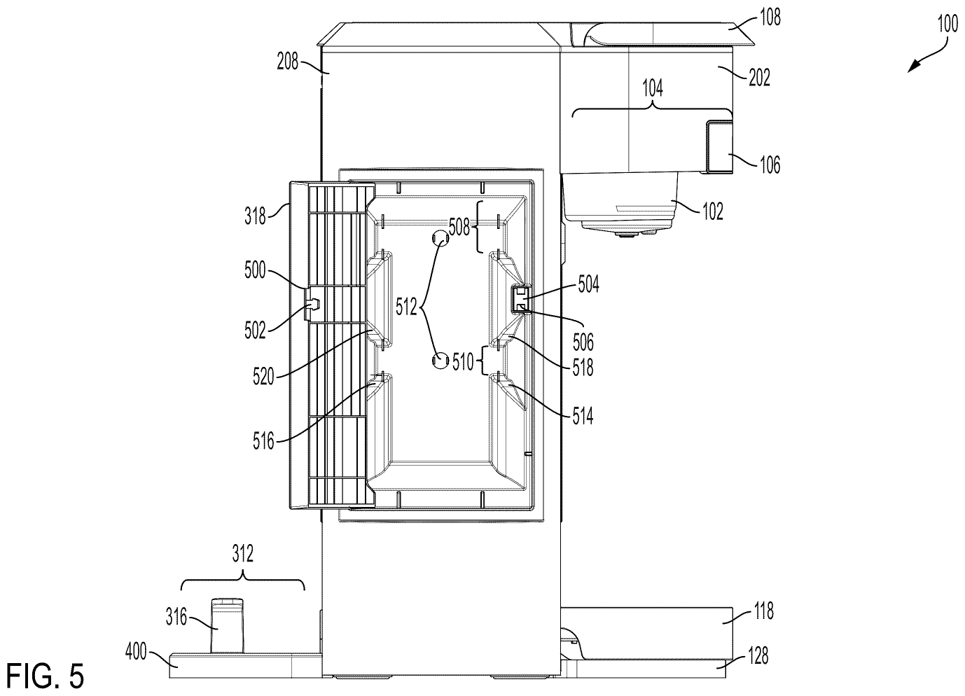

Turning now to FIG. 5, the same view as FIG. 4 is shown. However, in this view the plurality of adapters 402, including the first adapter 404 and the second adapter 406, have been removed from their respective locations within the adapter storage 208. To secure the adapter storage 208, the door 318 employ a a lock. The lock 500. The lock 500 may have a locking tab 502 present on the door 318. The locking tab 502 can then be received into and by a locking recess 504 located on a frame of the adapter storage 208. The lock 500 on the door 318 to the adapter storage 208 may be a push lock. Thus, when the locking tab 502 on the door enters the locking recess 504, the locking tab pushes the locking recess deeper into the frame of the adapter storage 208. In this fashion, the locking grips 506 of the locking recess 504 surround and contact protrusions on the locking tab 502 so that the locking tab is secured within the locking recess 504. Pushing the locking recess 504 allows the locking recess to positional change from the outward extended position viewed in FIG. 5 to the interior locking position by way of a mechanical switch. When the door 318 is locked in this fashion, pushing on the door 318 inwards into the adapter storage 208 mechanically switches the positional orientation of the locking recess 504. This allows it to then leave a locking position and via a spring force push the door 318 open and thus allowing access to the adapter storage 208.

Within the adapter storage 208, a plurality of track slot locations 510 and 512 may be present to house a plurality of adapter not in use. The name and use of an adapter w102 ill be viewable on the front plate of the adapter 102 and would be viewable in the such a storage position within the adapter storage 208. Each of the plurality of track slot locations 510 and 512 may have a top alignment track represented by elements 518 and 520 and a bottom alignment track represented by elements 514 and 516. The height of an adapter 102 is configured to fit between such tracks. Further, at the rear of the adapter storage 208 a storage lock 512 maybe present. The storage lock may be a magnet that can magnetically connect and secure an adapter via an adapter magnet to the rear of the adapter storage 208 and within one of the plurality of track slot locations 510 and 512. The viewed can house two adapters, but additional adapters may also be used and envisioned both for use with the brewed beverage maker 100 and for storage within the adapter storage 208.

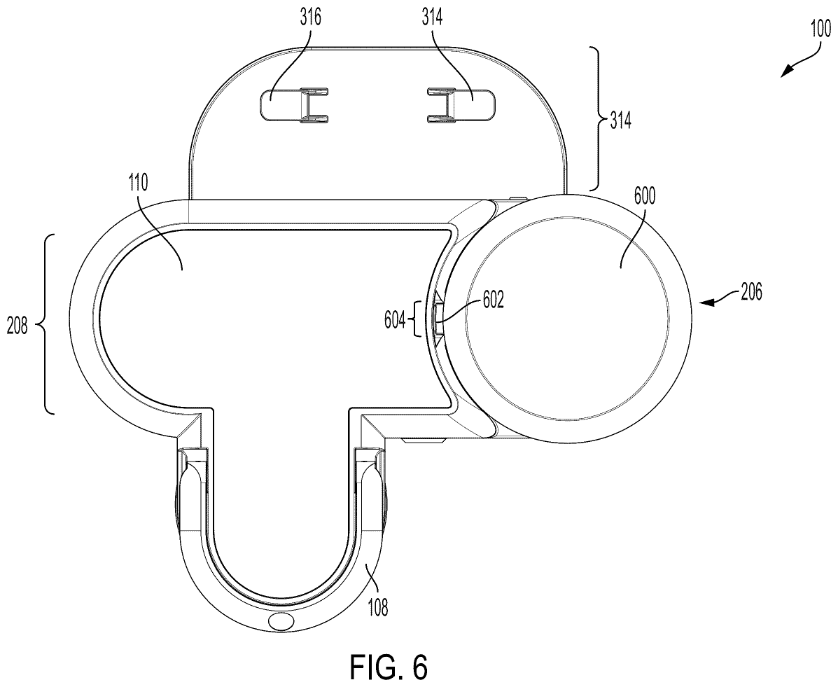

Turning now to FIG. 6, a top view of the example brewed beverage maker 100 with brewing adapters is viewed. In FIG. 6, the top housing panel 110 is viewed that covers most of the brewed beverage maker and protects the internal components of the brewed beverage maker. At the rear of the middle area the cord storage location 312 is viewed again with the cord storage extension 400 extended from and connected to the base of the brewed beverage maker. The lever 108 of the brewed beverage maker is also viewed in the operational closed position with use of an adapter 102 housed within the adapter chamber. On the right side of FIG. 6 the water tank 206 is viewed. In this top-down view, the water tank 206 has a water tank lid 600 that may fit onto and securely cover the top of the water tank 206. Further, the water tank may have a locking latch 602. The locking latch 602 of the water tank 206 can fit into and be secured by a locking recess 604 located on the top portion of the housing 112 near the water tank. Securing the water tank in this fashion to the housing 112 of the brewed beverage maker allow for easy transport of the brewed beverage maker 100nwithout the risk of detaching the water tank 206 and spilling its contents. On the left side of FIG. 6 the top-down view of the adapter storage 208 is shown. The door 318 to the adapter storage 208 is shown in the closed position.

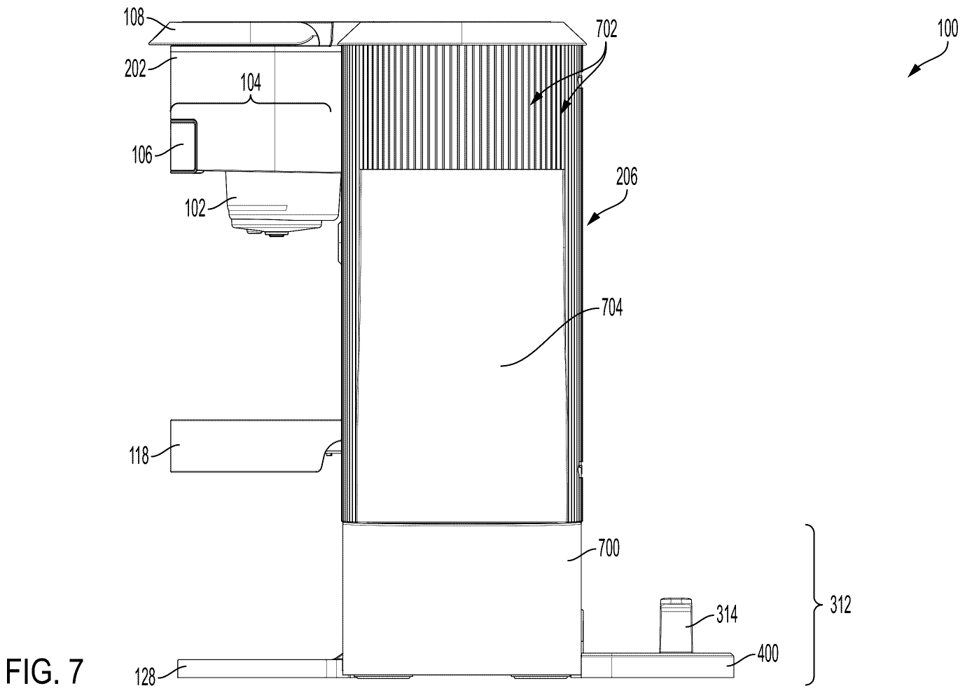

FIG. 7 shows a second side view of the example brewed beverage maker with brewing adapters. On the right side of FIG. 7 cord storage location 312 is viewed again with the cord storage extension 400 extending from the base of the housing of the brewed beverage maker. On the left side of FIG. 7, multiple components of the brewed beverage maker discussed above are viewed as well. Here, the lever 108 is viewed in the closed or operational position at the top of the brewed beverage maker. Below that the housing area for the actuator components and nozzle is present. Below that an adapter 102 is viewed positioned within the adapter chamber 104 and ready for operational use. Underneath the adapter, the drip tray 118 is present. The drip tray 118 is notched and connected to the housing in an upper position to fit a smaller container to hold a brewed beverage. Finally, under the drip tray 118 the drip tray aligner 128 is viewed attached to the base of the brewed beverage maker. FIG. 7 also provides a better perspective of how the drip tray aligner 128 helps balance and secure the brewed beverage maker from tipping over and falling. As can be understood in FIG. 7, the middle profile width of the brewed beverage maker is smaller than its length and height. Thus, the extension outward and the connection of the drip tray aligner 128 to the base of the brewed beverage maker helps it from tipping over and falling. The same can be restated for the cord storage extension 400 viewed on the right side of FIG. 7. The middle portion of FIG. 7 generally shows the overall water tank design. The water tank 206 is in the attached position to both the top of the housing 112 as well as to the lower housing extension 700 viewed in the middle portion and directly below the water tank 206.

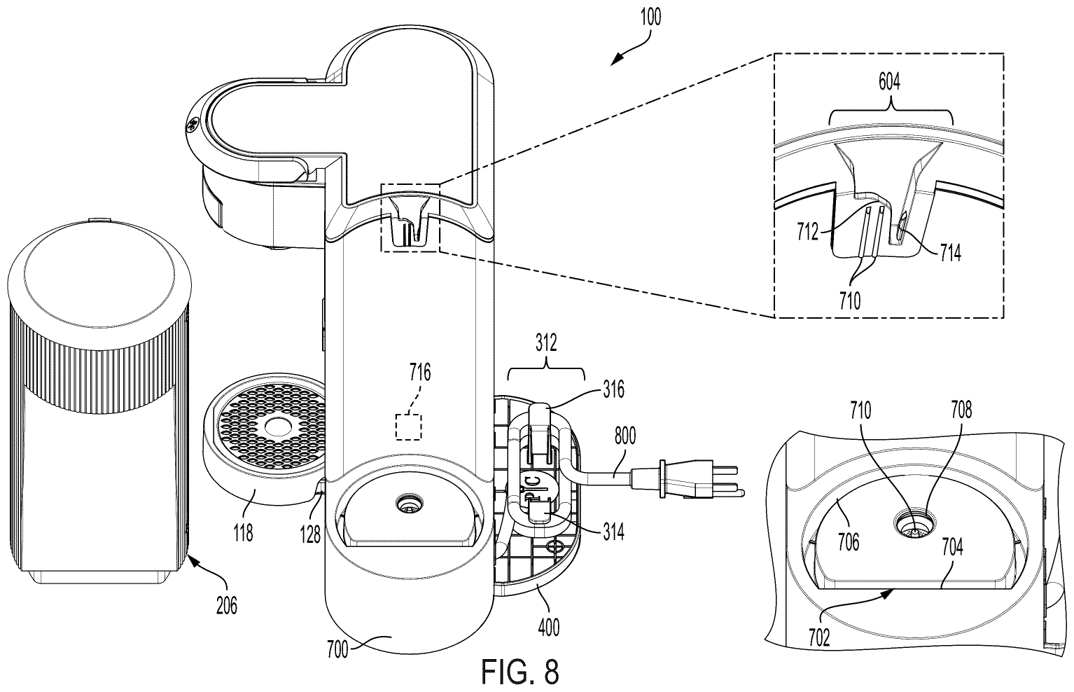

In FIG. 8, an alternate second side view of the example brewed beverage maker 100 with brewing adapters is viewed with the water tank 206 removed from the brewed beverage maker 100. In FIG. 8, the water tank and its associated connection to the housing 112 of the brewed beverage maker 100 is viewed in greater detail. The water tank can connect to the housing in two different positions. First, the water tank 206 rests at a predetermined positional arrangement into the housing 112 to the side of the main housing area. The housing 700 has a water tank channel 702 that is formed into and is part of the housing 700. The water tank channel 702 may have a straight part 704 of the channel before continuing to a circular part 706 of the channel. Also on the housing 700 is a water input inlet 708. That water input inlet 708 has a pin 710 that may reposition a pin of the water tank 206 that is movable between an open up positoin and a closed down position. Behind the housing 112, where a lower portion of the water tank 206 will rest, a sensor 716 may be present. When the water tank is removed, as viewed in FIG. 7, the water input inlet is in the closed position. This prevents unnecessary or possibly harmful debris from entering the water input inlet and causing damage to the internal components. In the closed position, a spring of the water input inlet biases a plug in an upward direction to securely seal the water input inlet from accepting any possible foreign matter or material. Additionally, the water tank 206 can connect to the upper area of the housing by a locking recess 604. In some embodiments, a control signal passed to the controller may indicate whether the water tank 206 is present within the locking recess 604 by way of switch 714. If it is not present, the brewed beverage maker 100 will not operate. The locking recess 604 may have an opening and an off set panel 712 away from the main housing area 112. Further, a plurality of guides 710 may have position the water tank 206 into the locking recess 604.

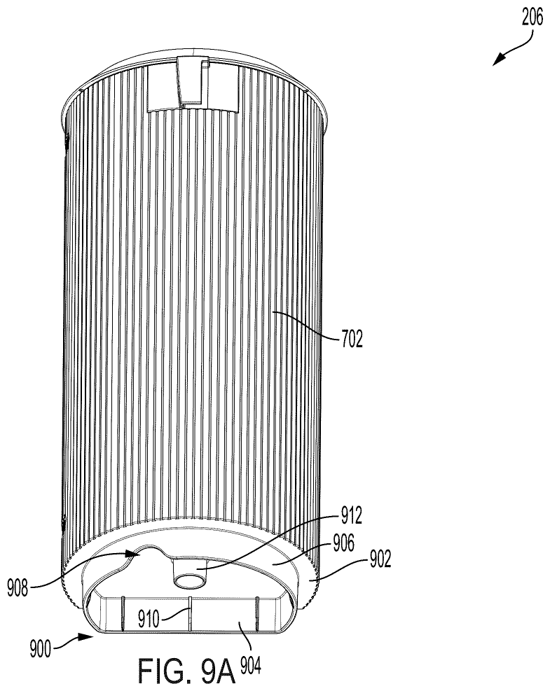

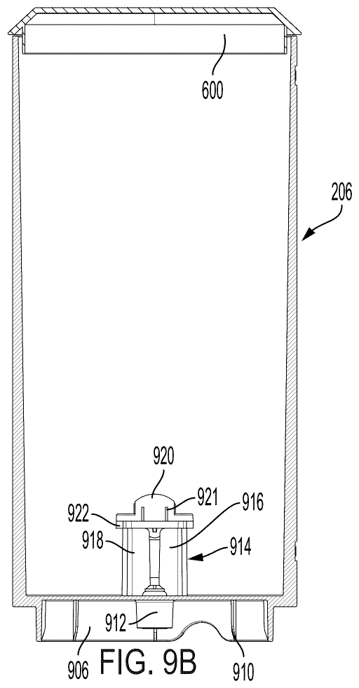

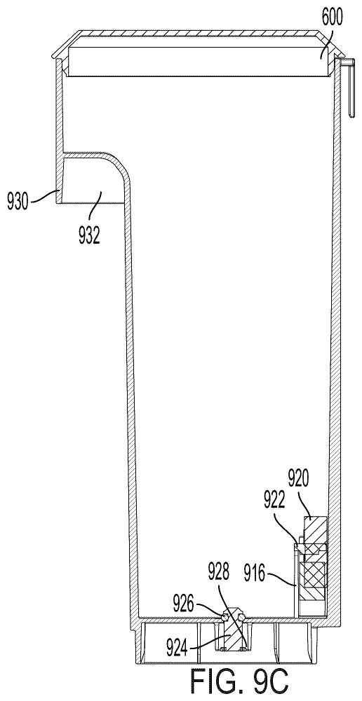

FIG. 9A shows a back tilting view of the water tank 206 usable with the brewed beverage maker 100. The bottom of the water tank 206 may have a water tank ridge 900 that circumscribes a portion of the bottom surface 902 of the water tank. The water tank ridge 900 extends from the bottom surface of the water tank outward and away from the water tank bottom surface 902 and is configured to match and mate with the water tank channel located on the housing of the brewed beverage maker. The water tank ridge 900 may have a straight section 904 and a circular section 906. A small portion of the water tank ridge 900 may contain a semicircular cut out 908 to fit in within a bump of the housing to correctly position the water tank. This small water tank cut out 908 provides for a minimal air gap so the air can enter and flow into the water tank to allow the water within the water tank to gravity feed the water input inlet as needed. Without minor airflow, a vacuum condition may occur with the water tank and water would not be able to leave the water tank and enter the internal components of the brewed beverage maker. The bottom of the water tank 206 also contains a circular extension 912 that extends downward and away from the bottom surface of the water tank 206. The circular extension 912 is designed to fit into and create a feed path from the water tank to the water input inlet. The diameter of the circular extension is hollow and provides direct access to the interior of the water tank. Further, the main body of the water tank 206 may have a ribbed design 702. Other areas may have a flat design 704. When the water tank is placed on the housing in the correct orientation, the circular extension 912 fits within the water input inlet.

FIG. 9B shows a cross-sectional view of the water tank 206 along a first axis. The water tank lid 600 is fit over the water tank 206. The interior of the water tank 206 may contain a side compartment 914. Within the side compartment 914, a float sensor 920 with magnetic properties may be placed. The compartment 914 within the water tank may be larger than the overall size of the float sensor 920. Thus, the float sensor 920 within the compartment 914 may be able to slidably move in an upward and downward direction. The compartment may have a plurality of side walls 916 and 918 that extend upward from the interior surface of the bottom wall of the water tank 206. Once the float sensor 920 is placed within the compartment a stopper 922 may be placed on the open top of the compartment 914 within the interior of the water tank. The stopper 922 may have rail guides 921 allow for a small but important range of movement for the float sensor 920 within the compartment 914. The stopper 922 prevents the float sensor 920 from leaving the compartment 914 and floating to the top of the water tank. When the water tank is attached to the housing in the correct orientation, the water tank is filled with water, and the float sensor 920 is positioned within the interior compartment of the water tank in the correct orientation, operation of the brewed beverage maker 100 can occur. Opposite the float sensor location positionally held by the stopper 922, and on the other side of the housing 112 as part of the internal components, a magnetic sensor 716 may be present. The magnetic sensor 716 is positioned to read and pick up the magnetic field of the float sensor 920 within the water tank 206. In the correct position within the compartment 914 and held by the stopper, the magnetic sensor 716 continuously confirms the magnetic field emitted by the float sensor. If the float sensor has moved from its desired position either through float sensor failure or low water levels, the emitted magnetic field of the float sensor would change and likely weaken. In this example, the magnetic sensor 716 within the housing would then transmit a signal to the controller of the brewed beverage maker 100 to accomplish at least one of two things. First, the signal sent by the magnetic sensor 716 may cause the controller to illuminate the low water light based on the reading from the magnetic sensor as that is the likely cause of the error. Second, as the magnetic sensor 716 cannot confirm the proper amount of water levels, the controller may suspend operation of the brewed beverage maker until either water is added to the water tank likely based on low water levels or other issues with the float sensor or magnetic sensor are addressed. This is one of the additional safeguards and protections offered by the brewed beverage maker.

FIG. 9C shows another cross-sectional view of the water tank along a second axis. Here the float sensor 920 is also view within compartment 914. The water tank 206 at the top may have a handhold 932 to lift the water tank out of the housing and an attached position. Further, the handhold 932 can be formed by a lower ridge extension wall 930 opposite where the water tank 206 attaches to the housing 112. At the bottom of the water tank 206, a movable pin 924 is present. The pin 924 can have and upper seal 926 that prevent the pin from being removed from the water tank. Further, a spring 925 may be present that biases the pin 926 into the lowest position with the seal contacting the bottom wall of the water tank. This stops water leakage from occurring when the water tank is removed from the housing 112. The pin within the housing 112 may contact pin 926 pushing the contracting spring 925 to release water into the water input inlet in the open position. When placed on the housing in this manner, the water tank can continuously feed the brewed beverage maker as needed to create the brewed beverages desired by the user. Further, the water tank inlet may, in some embodiments, connect to a sensor to determine a water tank connection. If a signal like this is received by the controller, the controller will not allow the brewed beverage maker 100 to operate until the water tank is replaced into the correct orientation for proper operation.

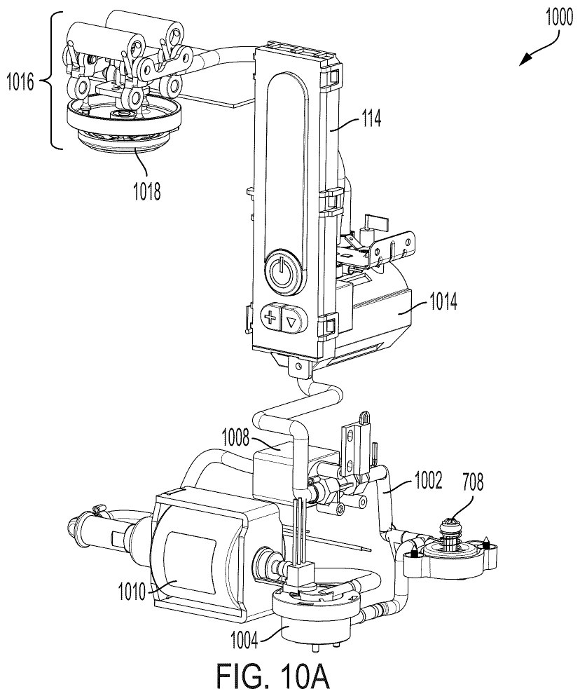

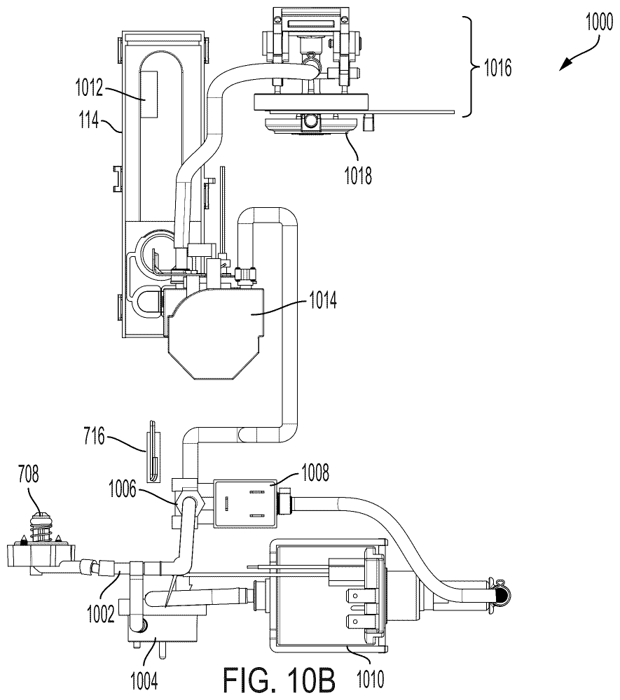

Next, in FIGS. 10A and 10B a front and back view of example internal operational components 1000 used to create the example brewed beverage maker 100 with brewing adapters is visible. The internal components viewed in FIGS. 10A and 10B are all located within the housing and protected by the housing of the brewed beverage maker. FIGS. 10A and 10B show the water input inlet 708. From the water input inlet, water flow tubes 1002 primarily connect the water input inlet to the flowmeter 1004 and a bidirectional valve 1006 near the power source 1008. The flowmeter controls the rate at which water enters the internal components of the brewed beverage maker. The flowmeter may receive power from the power source and be connected to the controller. Errors from the flowmeter related to water flow may cause the controller to stop functioning due to these errors. From the flowmeter, water flow tubes move the water and the controlled release of water from the flowmeter to the pump 1010 of the brewed beverage maker. The pump circulates and creates the needed pressure for the operation of the brewed beverage maker. The pump can connect as well to the power source and the controller 1012. It may receive power from the power source and report any errors to the controller 1012. The controller may cease operation of the brewed beverage maker if any pump errors are received. From the pump, the water moves via water flow tubes passing the power source. The power source can either be directly attached to the multiple components of the brewed beverage maker, or it can provide power to the controller to then distribute between the power needed components of the brewed beverage system. Further, the power source 1008 may include a rectifier circuit to change the alternating current received from the power cord outside of the brewed beverage maker into direct current required by at least some components of the brewed beverage maker. Passing the power source location, the water flows through the water flow tubes into the heater 1014 of the brewed beverage maker. The heater may also be connected to a plurality of fuses to help heat and control the water within the heater. The heater and the boiler fuses may communicate with the power source for energy needs and may also connect to the controller 1012. Errors received by the controller related to operation of the heater or the fuses may cease operation of the brewed beverage maker. Above the heater is a ground plate used to help ground any needed electrical components including the fuses. Additionally, sensors can also be attached to the heater to read pressure related values and report any issues back to the controller. The controller can the monitor these data points to executed any required changes in functional operation. Above the heater the controller 1012 may be present on a printed circuit board as part of the control panel 114. The controller can communicate with all electrically driven components and sensors related to brewed beverage maker. The controller may have a logic control circuit as well as a memory. The memory can store operational parameters for functional operation of multiple modes available for use by the brewed beverage maker, execute actions needed, or act on any received error codes or sensor values requiring system attention. Heated water then flows from the heater through additional flow tubes to the injection area 106 having the needle or nozzle. The injection area is near the adapter chamber 104 and any attached adapter. Another pressure sensor may be present near the nozzle or needle and report data back to the controller for interpretation and any operational actions needed on the data values received near the nozzle or needle. A control panel 114 may be present with the controller 1012. The control panel can display information to the end user as well as receive inputted commands from the user regarding a brewing selection or other action. Below the needle or nozzle is the sealing member that may be moved in a downward direction by the gears located above the sealing member and nozzle or needle. The sealing member may pressingly engage with the top surface of an adapter 102 positioned within the adapter chamber when the lever is moved to the closed or operational position. The actuation of the lever to the closed position also moves the needle or nozzle downward as well and into the interior of the adapter within the adapter chamber to create the brewed beverage requested.

Further, the controller may be in communication with a plurality of different magnetic sensors. One magnetic sensor may be positioned near the water tank approximate to the area where the magnetic float may be housed to monitor the water level and communicate data points back to the controller. Additionally, a plurality of magnetic sensors may also be present in positions near the adapter chamber. One magnetic sensor may be near the magnet that connects the adapter within the adapter chamber. If a change in the magnetic field is sensed within an appropriate threshold, the magnetic sensor may communicate to the controller that the connection of the adapter within the adapter chamber is secure and also identify the adapter that is present. Then, and brewing operation according to the secured adapter may commence backed on stored parameters of the adapter 102 controlled by the controller 1012.

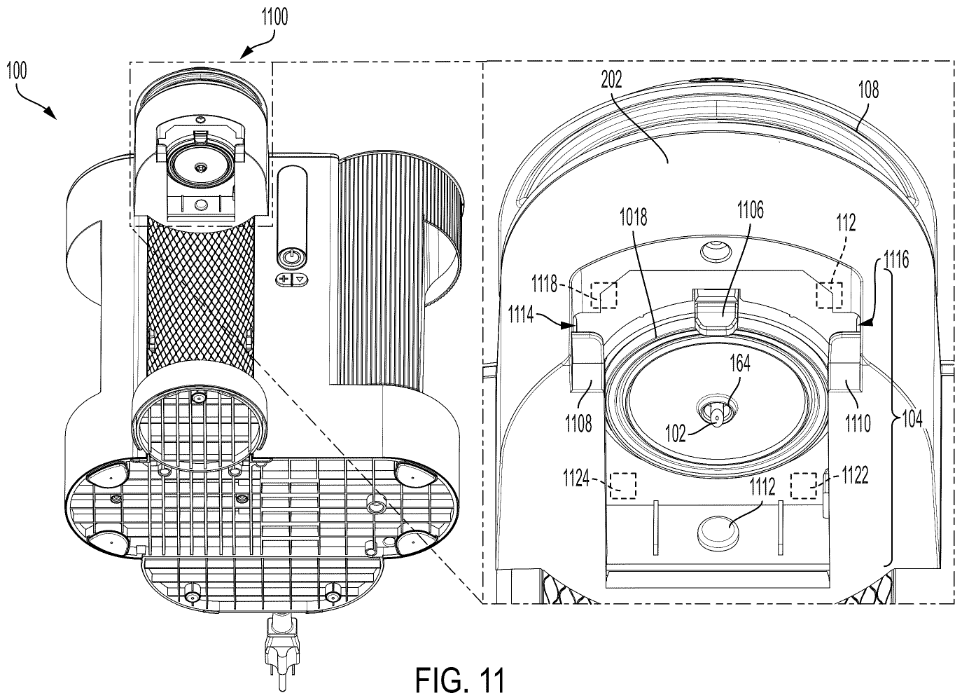

FIG. 11 shows a front view of the example brewed beverage maker wherein a adapter is not located within the adapter chamber 104. An enhanced view 1100 of the adapter chamber 104 is viewed to the left. As discussed above, the brewed beverage maker 100 can be used with multiple brewing adapters. FIG. 11 shows the lever in the closed position. Without the adapter, it can be seen how some of the internal components of the brewed beverage maker are actuated when the lever is in the close or operational position. Viewing the adapter chamber 104 in closer detail 1100, the sealing member 1018 can be viewed extending downward from the roof of the adapter chamber 104. The sealing member is circular in nature and may have O-ring or additional rubber type contact seal that can be actuated downward with the sealing member to contact the adapter within the adapter chamber. Viewing FIG. 11, it is assumed that the adapter top surface would be generally flush with the top surface of the adapter chamber. While the sealing member 1018 may move downward in a further direction, it may also likely contact and secure the in the position viewed in FIG. 11. The needle 1104 is also viewed in FIG. 11 through a needle recess 1102 and can piece a top surface of a container as needed based on the operational use of the brewed beverage maker. In other embodiments, the needle may also travel lower into the adapter chamber 104 in certain embodiments. In front of the sealing member, an adapter locking tab 1106 is present. The adapter locking tab 1106 may move from an enclosed position within the housing above the adapter chamber when the lever is in the open position to the locking position viewed in FIG. 11 when the lever is placed into the closed position. Here the adapter locking tab is in the locking position. When an adapter is placed into the adapter chamber the adapter 102 may have an opening where the adapter locking tab 1106 can enter and further secure the adapter within the locking chamber. In some embodiments, when the lever is moved into the open position, each the needle, the sealing member, and the locking tab will lift from their contacting positions with the adapter within to the adapter chamber and return to their primary location enclosed within the housing above the adapter chamber. In some embodiments, when the lever is moved to the open position a second lever may extend down from the top or outward from the back of the adapter chamber to help kick or dislodge the adapter from the adapter chamber so that it can be removed if no longer needed.

To fit within the adapter chamber 104, a plurality of adapter track slots 1114 and 1116 are present on either side of the adapter chamber. When the lever is in the open position, the user may select an adapter of choice and place it into the adapter chamber guided by the track slots on either side of the adapter chamber. All adapters of the brewed beverage maker have generally common design in that they attach to the adapter chamber in the same manner via the track slots. When the adapter is placed into the adapter chamber, the user will push it backward along the track slots. The track slots may have lower guides 1108 and 1110 to secure the adapter. In the middle center portion at the back of the adapter chamber and in line with the track slots a button item 1112 is present. This button type item may be a magnet that may or may not be part of the back housing area behind the adapter chamber. Either way, the adapter chamber magnet connects to a magnet located on the back of each of the adapters to initially secure it within the adapter chamber by way of the track slots. The adapter magnet when magnetically attached to the adapter also helps ensure that the adapter is located all the way to the back of the adapter chamber and in the proper position for functional operation of the brewed beverage maker.

Further, below each of the track slots where the adapter is to be placed and moved to the back of the adapter chamber, a plurality of guide rails 1108 and 1110 are present. While the front portion of these guide rails may be a general housing structure. At the top of the track slots, a plurality of magnetic sensors 1118, 1120, 1124, and 1122 embedded near the surface of the track slots may be located above the adapter behind the housing. Each magnetic sensor about each guide rail and the tracks may pick up local magnetic fields near the corresponding magnetic sensor. Depending on any reading picked up by these magnetic sensors, a corresponding signal is sent to the controller for overall operation of the brewed beverage maker.

The magnetic sensors located at the back of the adapter chamber and above the track slots determine what type of adapter is inserted into the adapter chamber. Each adapter has two openings in the back of the adapter, and two openings near the front of the adapter area. All four may be be near the location of these magnetic sensors when placed in the adapter chamber. A magnet may be optionally place into one of these openings within the adapter and identified by these sensors. Thus, a logic table to 16 possible operations could be accomplishes with additional ones if the back securing magnet keeping the adapter within the adapter chamber is used. Thus, a Boolean Logic table, for example of 00, 01, 10, 11, for some of the plurality of magnetic sensors can be created from the readings of these magnetic sensors. Further, each adapter may be assigned a logic code based on these readings within the memory of the controller so that it can easily be recognized and the operational parameters for each adapter can be set within the controller. While codes 01, 10, and 11 are usually assigned to the adapters present in this embodiment of the brewed beverage maker, 00 can also be assigned. In some instances, the state of 00 relates to the presence of no adapter within the adapter chamber and acts as a safety to ensure improper operation of brewed beverage maker does not occur.

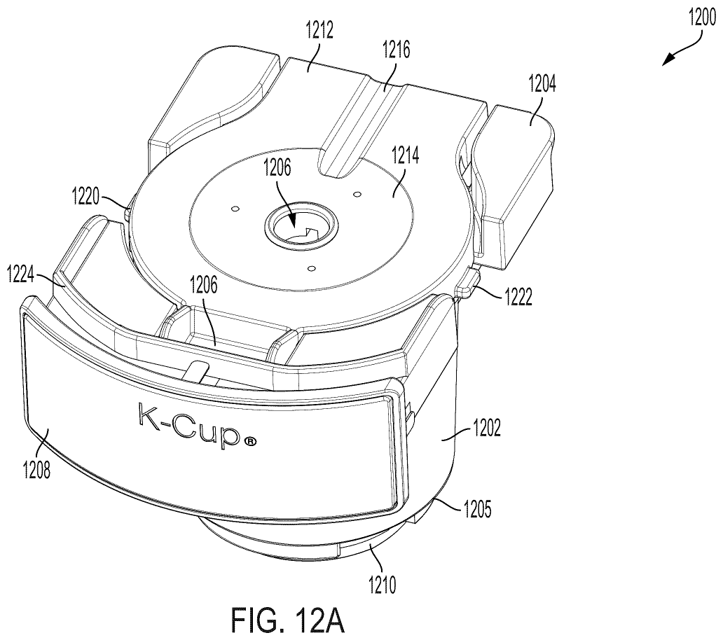

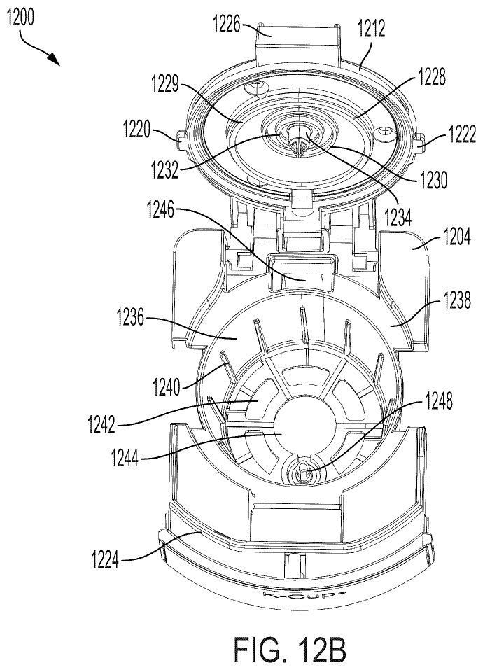

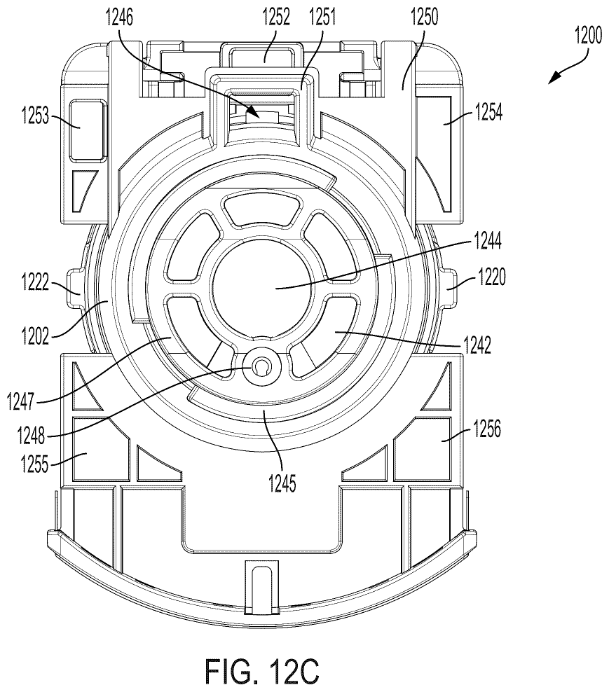

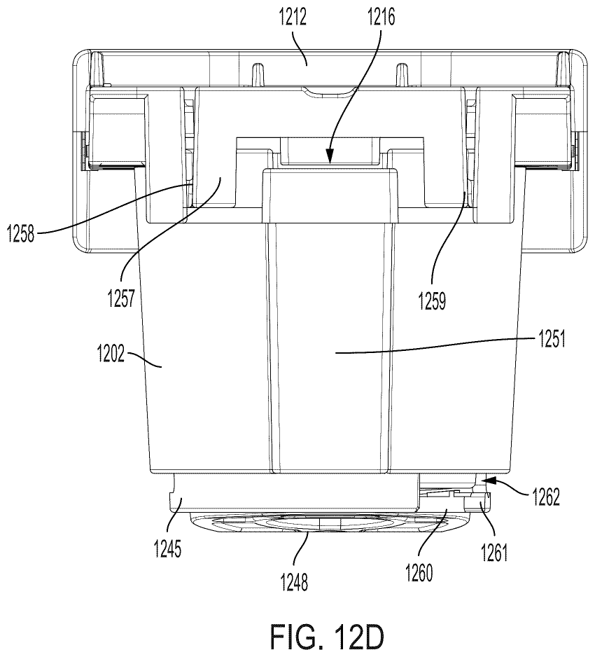

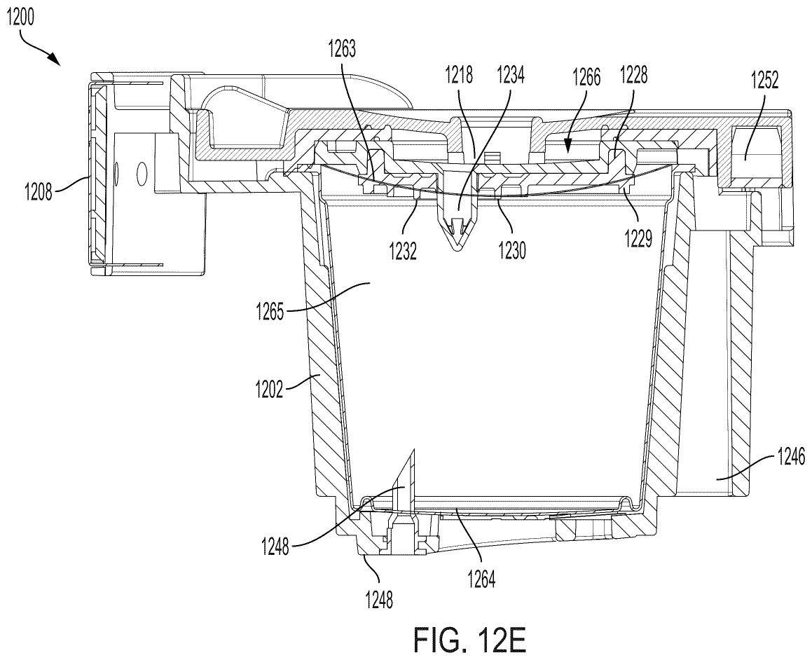

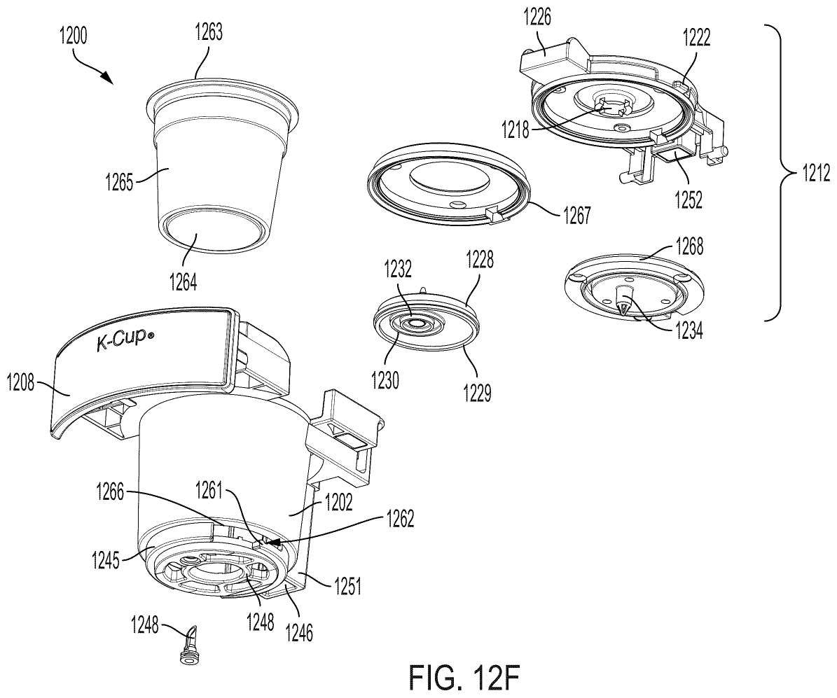

In FIG. 12A, shows a coffee pod adapter 1200 for possible use with the example brewed beverage maker. The coffee brewing adapter has a general cartridge 1202 form that is insertable into the adapter chamber as needed for operational use with the brewed beverage maker. Generally central on the cartridge form is a recess 1218 into which a needle can pass. The cartage 1202 may have a top surface. At the front, the cartridge may have a tab recess used to secure the adapter within the adapter chamber. The coffee pod adapter 1200 may have a front plate 1208 with the name of the adapter. The coffee pod adapter 1200 may have a interior bottom surface 1210 of the cartridge and an exterior bottom surface 1205. The coffee pod adapter 1200 may also have a lid 1212. The lid may have a lower lid surface 1214 through which the recess 1218 travels. The lid may also have a channel 1216 were overflow and run off may travel during operational use. Additionally, the lid may have a first side tab 1222 and a second side tab 1224 to grip and lift the lid. For additional overflow protection, the front of the coffee pod adapter 1200 may have a blocking wall 1224 to prevent frontward spills.

FIG. 12B shows a top down perspective view of a coffee pod adapter 1200, without a coffee pod, and with an open lid. The lid may have a front tab 1226 to over the lid and it may house a magnet. The lid may have a seal 1228 having an outer seal 1229, a middle seal 1230, and an inner seal 1232. All seals may surround a needle 1234. At the back of the coffee pod adapter 1200, at the rear of the cartridge, a overflow channel 1246 may be present for loose or leaking liquid. The cartridge may have a top rest shelf 1238 were part of a coffee pod insert may rest. The well 1236 of the coffee pod adapter 1200 is present. The well may have a plurality of side protrusions 1240. The well have a plurality spaced base openings 1242. The well may also have a center opening 1244. As the bottom of the well, a bottom needle 1248 maybe present to piece an inserted pod.

FIG. 12C shows a bottom view of a coffee pod adapter 1200. The magnet 1252 may be located positionally attached to the lid. The channel may have a channel side wall 1251. The flow point 1246 may be present to feed the channel from the cartridge overflow. A plurality of magnet positions 1253, 1254, 1255, and 1256 may be present where magnets can be read by sensors to determine that the insert adapter is a coffee pod adapter 1200.

FIG. 12D shows a back view of a coffee pod adapter 1200. The lid may have a lid hinge 1257 with a plurality of connectors 1258 and 1259 housed in the cartridge. The lower area of the cartridge may have a opening 1262 to fit a flow director. It may be house between a portion 1261 and the may exterior surface side wall 1245. The interior surface side wall 1260 may contact any held flow director piece.

FIG. 12E shows a cross sectional side view of a coffee pod adapter 1200. A coffee pod 1265 may be present in the well of the cartridge. The pod may have an upper cover 1263 and a lower surface 1264. The needle may shoot water againd a plate off center of the neddle 1234 entering the pod. A flow chamber 1266 may be present to direct the flow of water from the machine needle.

FIG. 12F shows an exploded view of components used in a coffee pod adapter 1200. The lid may have a top connector component 1267 where the seal 1228 fits into the lid. The needle may be on a needle plate 1268

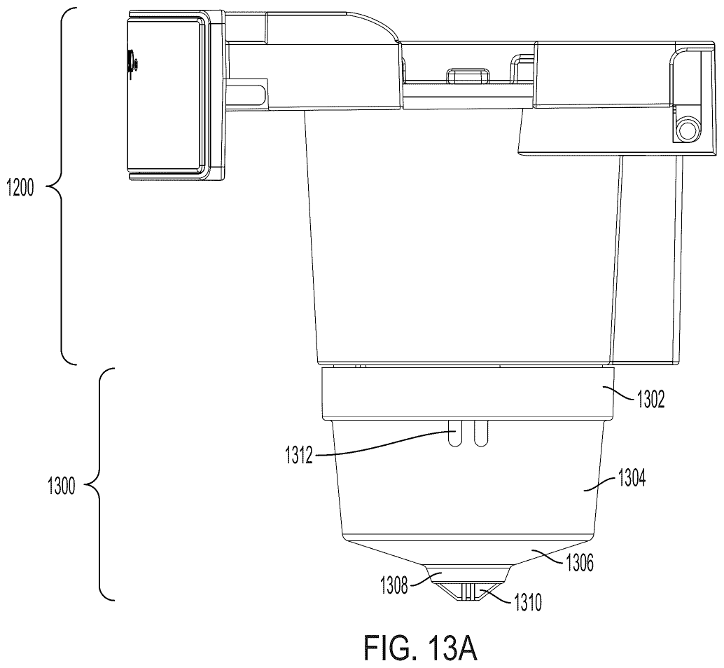

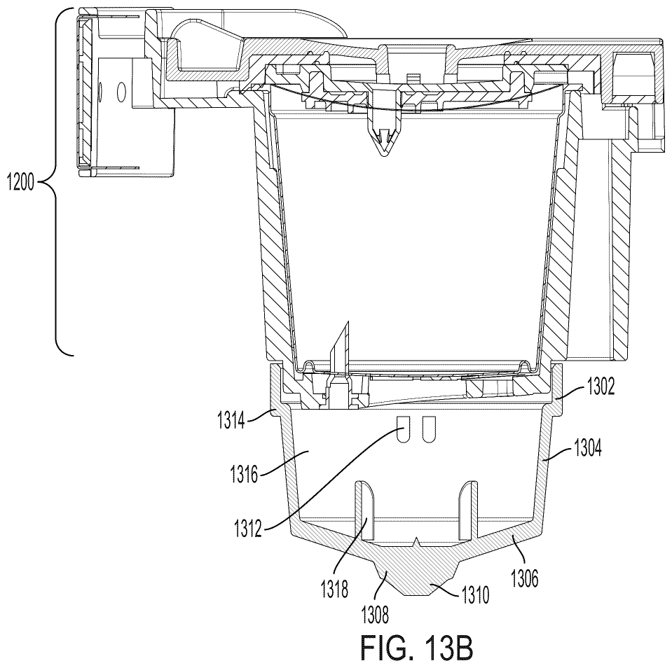

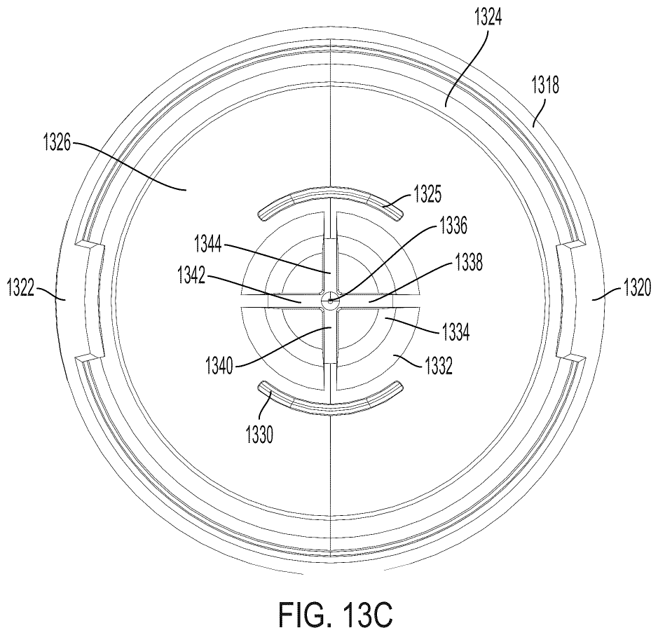

FIGS. 13A-C shows a side view of a flow director 1300 usable with the coffee pod adapter that may be used with the brewed beverage maker. The flow director 1300 has a top side wall 1302. The flow director 1300 has a well 1304. The flow director 1300 has a lower base 1306. The flow director 1300 has an output channel 1308. The flow director 1300 has a plurality of outlets 1310. The flow director 1300 also has a plurality of air gap contact points 1312. The flow director 1300 has a resting connection 1314. The flow director 1300 has a plurality of internal fins 1318. The flow director 1300 has connection openings 1320 and 1322. The flow director 1300 has outlet center 1336, fins 133, 1338, 1342, and 1340.

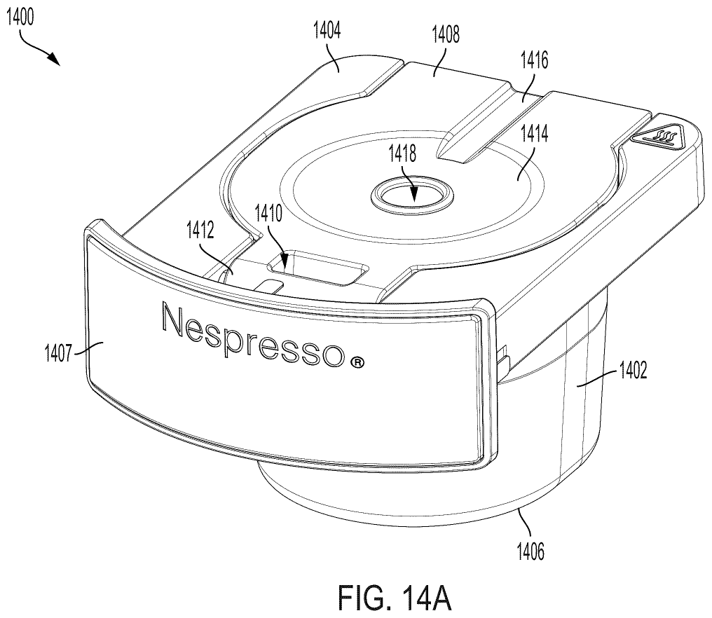

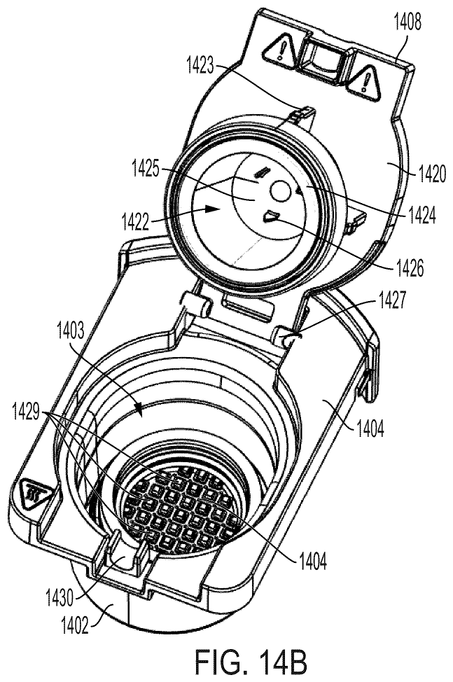

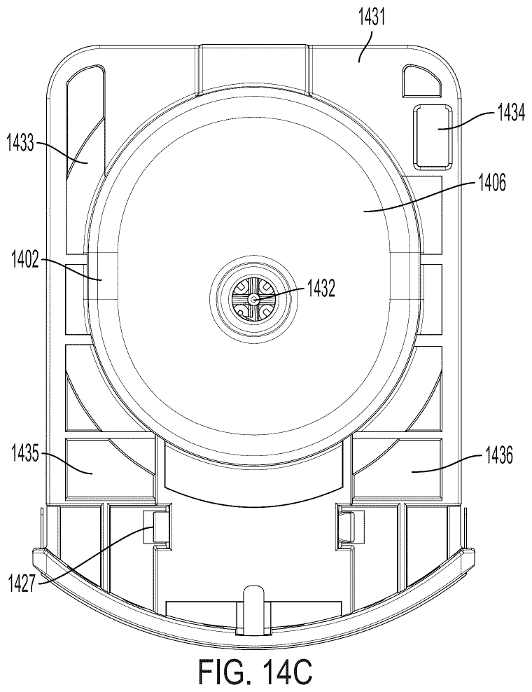

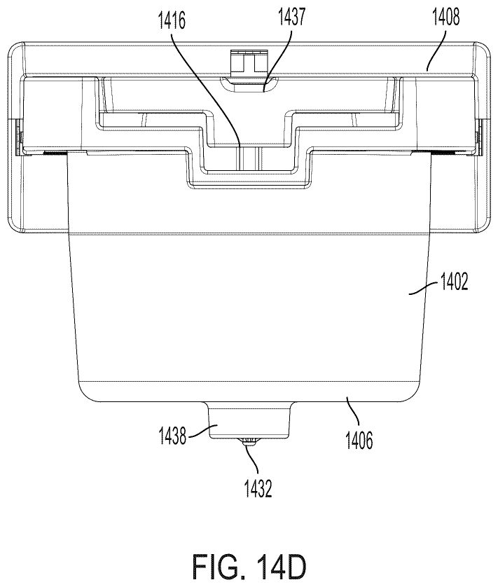

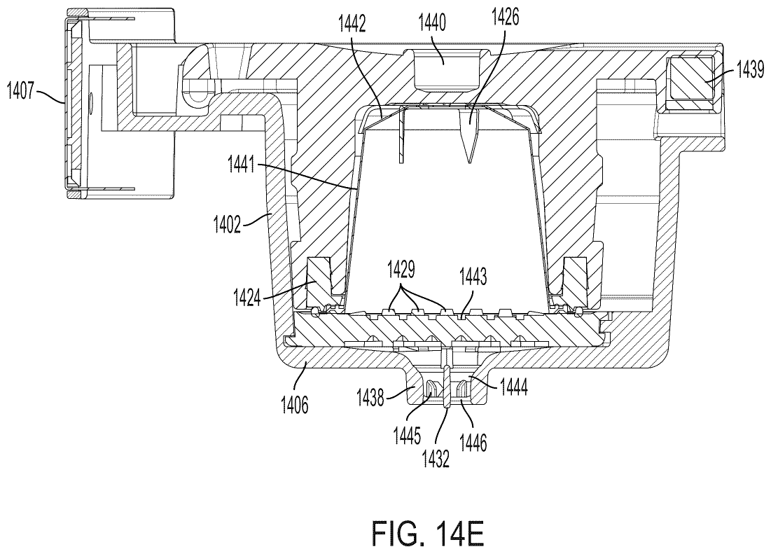

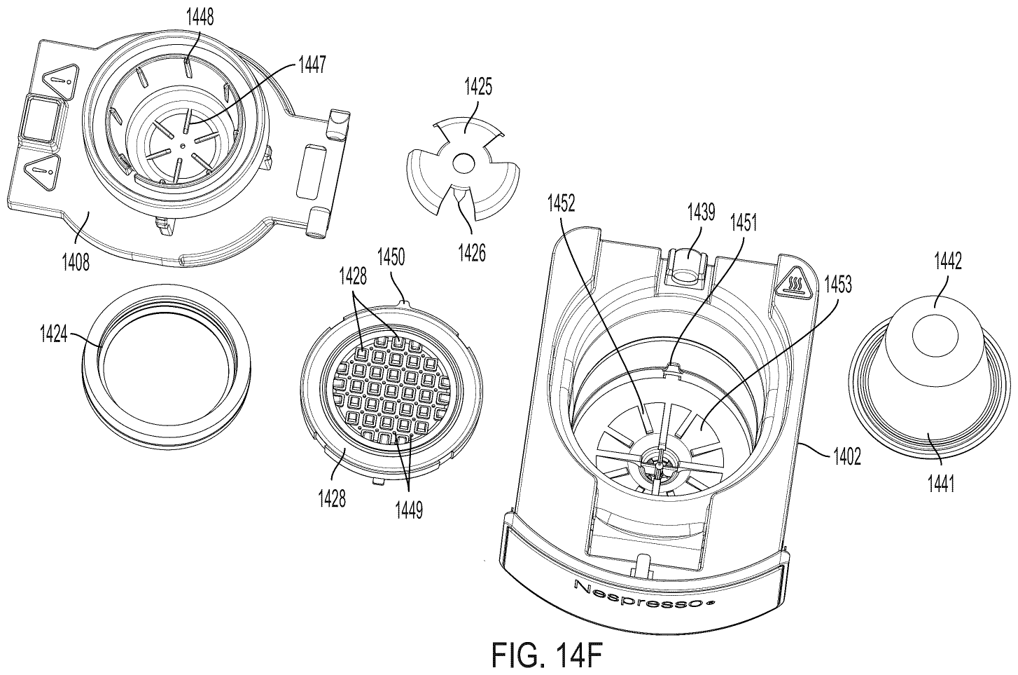

FIG. 14A shows a perspective view of an espresso pod adapter usable with the brewed beverage maker in accordance with an embodiment of the disclosure.

FIG. 14B shows a top down perspective view of an espresso pod adapter, without an espresso pod, and with an open lid, that may be usable with the brewed beverage maker in accordance with an embodiment of the disclosure.

FIG. 14C shows a bottom view of an espresso pod adapter usable with the brewed beverage maker in accordance with an embodiment of the disclosure.

FIG. 14D shows a back view of an espresso pod adapter usable with the brewed beverage maker in accordance with an embodiment of the disclosure.

FIG. 14E shows a cross sectional side view of an espresso pod adapter usable with the brewed beverage maker in accordance with an embodiment of the disclosure.

FIG. 14F shows an exploded view of components used in an espresso pod adapter that may be used with the brewed beverage maker in accordance with an embodiment of the disclosure.

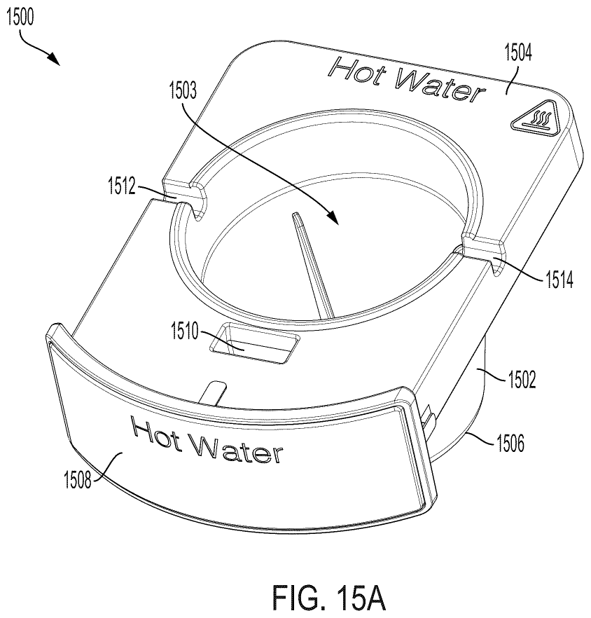

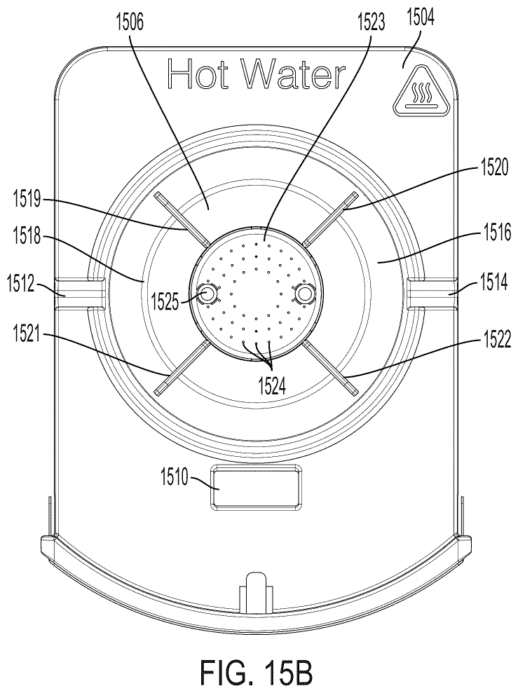

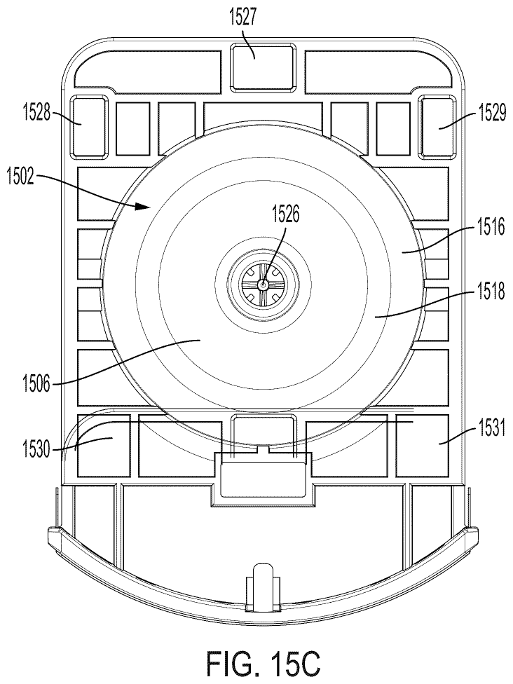

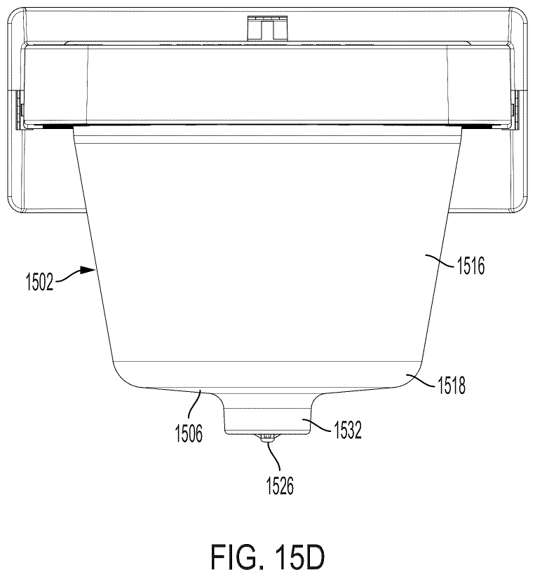

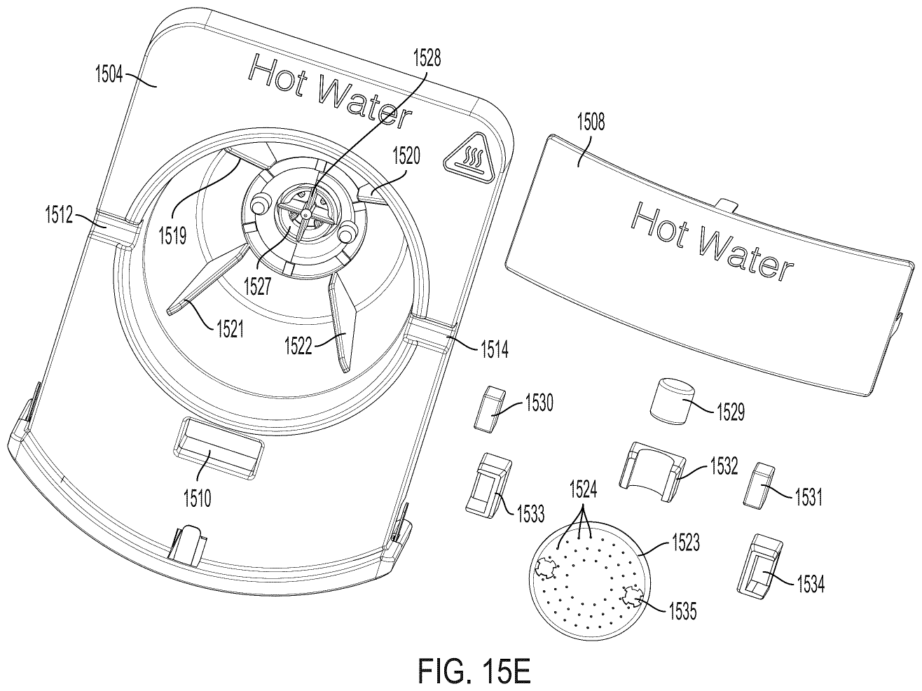

FIG. 15A shows a perspective view of a hot water adapter usable with the brewed beverage maker in accordance with an embodiment of the disclosure.

FIG. 15B shows a top down view of a hot water adapter that may be usable with the brewed beverage maker in accordance with an embodiment of the disclosure.

FIG. 15C shows a bottom view of a hot water adapter usable with the brewed beverage maker in accordance with an embodiment of the disclosure.

It extends downward from the top surface of the cartridge form through the bottom surface of the cartridge form. The interior of the well may have side protrusions extending into the interior of the well to adjust the placement of the coffee container to be centered placed within the well. In the front of the well on the top surface of the cartridge form, a top surface opening is present. The top surface opening on the coffee brewing adapter may be configured to receive the adapter locking tab from the brewed beverage maker with the lever is moved from the open position to the locked position to lock the coffee brewing adapter in place within the adapter chamber. On the front of the coffee brewing adapter a name plate may be present. The name plate may identify to the user the type of brewed beverage that can be made with the selected adapter when used with the brewed beverage maker. Further, the well may also have a well rest shelf. That circumnavigates the well location and is slightly depressed into the top surface of the cartridge form. The coffee container, when placed within the well, may rest on the well rest shelf in certain embodiments of the brewed beverage maker. Further, each the right and left side of the well may mate with a first and second grasping indentation. The first and second grasping indentation is semicircular in design and allows the user to place the coffee container into the correct orientation. Additionally, after use the first and second grasping indentations allow for the coffee container to be easily grasped and removed by the user to be discarded after the coffee by way of the coffee brewing adapter is brewed with the brewed beverage maker. Next to the coffee brewing adapter is an example coffee container. The viewed coffee container may be a single serving of coffee usually sold with this general design and configuration.

On the right side of FIG. 12, a back view of the coffee brewing adapter is viewed. As viewed from the back, the general cartridge form is visible moving from a front end near the name plate to the back end of the coffee brewing adapter. The back side of the cartridge form may be flat and planer. Thus, when placed within the adapter chamber the back side of the cartridge form may be flush against the back side of the adapter chamber. In the middle of the back side of the cartridge form, a magnet may be present. The magnet may allow the coffee brewing adapter to magnetically connect with the magnet within the adapter chamber so that the coffee brewing adapter is snug and secure within the correct location of the adapter chamber for brewing. At the bottom of the well, is a brewed beverage opening. The bottom surface of the well is slightly sloped downward toward the brewed beverage opening so that any brewed beverage, like coffee, is removed from the well through the brewed beverage opening so that it is collected in the container of choice of the user.

In FIG. 12, two additional alternate views of the coffee brewing adapter of the multiple brewing adapters that may be used with the example brewed beverage maker are shown. The view on the left is a top-down view of the coffee brewing adapter. With this view, the well is clearly defined as well as the side protrusions extending into the interior of the well to adjust the placement of the coffee container to be centered placed within the well. Also present is the top surface opening on the coffee brewing adapter may be configured to receive the adapter locking tab from the brewed beverage maker with the lever is moved from the open position to the locked position to lock the coffee brewing adapter in place within the adapter chamber. Further present is the first and second grasping indentation on the right and left sides of the coffee brewing adapter. The first and second grasping indentations allow for the coffee container to be easily grasped and removed by the user to be discarded after the coffee by way of the coffee brewing adapter is brewed with the brewed beverage maker. The first and second grasping indentations may also help with placement of the coffee container before brewing occurs. Viewable in FIG. 12 is also a lower needle. The lower needle is affixed to the lower surface of the well and extend upward in a vertical direction. The lower needle is not completely solid. While the tip of the lower needle is solid, the lower portion of the needle has an opening on at last half of the lower needle where air can enter, or a brewing beverage can exit through the lower needle. In operational use, the user will place the coffee container into the well of the coffee brewing adapter. When placed in the well, the user will then depress the coffee container deeper into the well to place it level with the top surface of the cartridge form. Depressing the coffee container in the manner punctures the lower surface of the coffee container with the lower needle. When the coffee container is placed in this manner and level with the top surface of the cartridge form the coffee brewing adapter is ready for use within the adapter chamber.

On the left side of FIG. 12, a bottom view of the coffee brewing adapter is visible. The brewed beverage opening of the coffee brewing adapter is shown. The opening may have a cross bar to further help filter out brewed beverage out of the well and into the user's container of choice. Also shown in FIG. 11 is the location where the plurality of magnets may be placed so that the controller can recognize the type of adapter inserted into the adapter chamber. A first magnet location may be located in the back left corner of the coffee brewing adapter and the magnet to be placed in the first magnet location may be affixed to remain in this location. A second magnet location may be located in the back right corner of the coffee brewing adapter and the magnet to be placed in the second magnet location may be affixed to remain in this location. For the coffee brewing adapter, a magnet may be placed in the second magnet location so that the controller recognizes that the adapter inserted into the adapter chamber is the coffee brewing adapter.

Turning to FIG. 12, two views of an espresso brewing adapter of the multiple brewing adapters that may be used with the example brewed beverage maker are visible. The view on the right shows the espresso brewing adapter from a top-down angled view. The espresso brewing adapter has a general cartridge form that is insertable into the adapter chamber as needed for operational use with the brewed beverage maker and similar to the coffee brewing adapter. Generally central on the cartridge form is a lid that may cover a well that extends downward from the top surface of the cartridge form through the bottom surface of the cartridge form. The lid of the espresso brewing adapter is viewed in a brewing or storage position here as it is flat and planar with the overall top surface of the cartridge form. The lid of the espresso brewing adapter may be movable from this closed position for brewing or storage to an open position to accept an espresso container. The top surface opening on the espresso brewing adapter may be configured to receive the adapter locking tab from the brewed beverage maker with the lever is moved from the open position to the locked position to lock the espresso brewing adapter in place within the adapter chamber. On the front of the espresso brewing adapter a name plate may be present. The name plate may identify to the user the type of brewed beverage that can be made with the selected adapter when used with the brewed beverage maker.

On the right side of FIG. 12, a back view of the espresso brewing adapter is viewed. As viewed from the back, the general cartridge form is visible moving from a front end near the name plate to the back end of the coffee brewing adapter. However, the presence of the lid in the closed position helps create the general cartridge form of the flat and planar top surface. Even with the lid, the back side of the cartridge form remains relatively flat and planer. Thus, when placed within the adapter chamber the back side of the cartridge form may be flush against the back side of the adapter chamber. In the middle of the back side of the cartridge form, a magnet may be present. The magnet of the espresso brewing adapter is located with the lid of the espresso brewing adapter and has a chamber created to hold it in the correct position. The magnet may allow the espresso brewing adapter to magnetically connect with the magnet within the adapter chamber so that the espresso brewing adapter is snug and secure within the correct location of the adapter chamber for brewing. At the bottom of the well, is a brewed beverage opening. The bottom surface of the well is generally flat but may slope slightly toward the brewed beverage opening so that any brewed beverage, like espresso, is removed from the well through the brewed beverage opening so that it is collected in the container of choice by the user.

FIG. 13 shows two alternate views of an espresso brewing adapter of the multiple brewing adapters that may be used with the example brewed beverage maker. The first image viewed in FIG. 13 on the left side is of the espresso brewing adapter where the lid of the espresso brewing adapter is open. The lid may have some additional components of the espresso brewing adapter attached to it in operational user. The lid has a lid cavity. Within the lid cavity a puncturing tool is affixed or attached to the bottom surface of the lid within the lid cavity. The puncturing tool is configured to puncture an espresso container when used by the user. The puncturing tool of the espresso brewing adapter may have three separate prongs to puncture the espresso container in multiple places. Also, attach at the terminal end of the lid that will be placed into the well, a sealing ring may be present within a defined sealing ring space of the lid. The sealing ring may rest around the espresso container as it sits within the well of the espresso brewing adapter. When the lid is in the closed position and the espresso brewing adapter is placed within the adapter chamber for operational use, pressure by the sealing mechanism of the brewed beverage machine presses down on the lid which in turn allows the sealing ring to press down on the edge of the espresso container placed within the well. Depending on the amount of force, this pressing action by way of the sealing mechanism to the lid may force the foil covering of the espresso container to additionally rupture. Also seen in the first image of FIG. 13 is the espresso container placed within the well of the espresso brewing adapter in the correct position for brewing. It should be noted that the espresso container is to be placed in the opposite configuration of the coffee container used with the coffee brewing adapter.

The second image or the right image of FIG. 13 shows the lid detached from the cartridge form of the espresso brewing adapter. Further, the espresso container is also removed from the inside of the well. As viewed in both images in FIG. 13, the lid can be opened toward the name plate of the espresso brewing adapter. In this image of FIG. 13, the interior of the well is viewed in detail. The well of the espresso brewing adapter may have a well rest shelf. The rest shelf may circumnavigate the well location and is slightly depressed into the top surface of the cartridge form. The lid when moved to the closed position within the well may rest on the well rest shelf in certain embodiments of the brewed beverage maker. Moreover, the interior of the well may have ring protrusions circling the interior of the well to aid in the placement and location of the lid when is it is moved to the closed position. At the bottom of the well, a filter may be present. The filter may fit within an interior recess within the well specifically crafted for the filter of the espresso brewing adapter. The filter may have a first surface and a second surface. The first surface faces upwards and is the surface on which the espresso container may be placed. The first surface has a plurality of small, raised surfaces. The plurality of small, raised surfaces are generally square pyramid shaped. When the lid is closed with a contained espresso container, and the espresso brewing adapter is placed into the adapter chamber, operational use of the brewed beverage maker may push the espresso container with the foil top wrapper against the plurality of small, raised surfaces to further puncture the espresso container.

FIG. 14 shows two more additional alternate views of an espresso brewing adapter of the multiple brewing adapters that may be used with the example brewed beverage maker. The first image set of images on FIG. 14 shows an exploded view of the multiple different components that are used to create the espresso brewing adapter. As viewed and discussed above, the lid of the espresso brewing adapter is viewed in a closed position. The lid may attach to the espresso brewing adapter near the name plate and be moveable between an open and a closed position. The espresso brewing adapter is also viewed in its generally cartridge form. The well of the espresso brewing adapter is viewed in further detail. At the bottom of the well, a number of resting extensions are viewed surrounding the brewed beverage opening. The filter can rest on the number of resting extensions when placed within the interior recess within the well near the brewed beverage opening. The sealing ring is also viewed outside of its contained position within the lid. Also, the puncturing tool is viewed both in its configuration where it is affixed within the lid and near the lid bottom surface and in a rotated position where the plurality of prongs can be viewed. The magnet which attached with the lid is view outside of its created cavity within the lid. This magnet attaches to the magnet in the adapter chamber during operational use of the espresso brewing adapter. The espresso container is also present. The espresso container is in the downward facing position as that is the optimal used for brewing an espresso beverage with the espresso brewing adapter. The espresso beverage may rest upon a filter which may nest inside the well of the espresso brewing adapter in a specific orientation. The espresso container may rest upon the first surface of the filter. The first surface of the filter has a plurality of small, raised surfaces that are generally square pyramid shaped and may puncture the foil film of the espresso container with force. The filter also has a second surface that is different from the first surface. The second surface of the filter contains a plurality of drainage holes through which the brewed espresso can pass on its way to the brewed beverage opening of the espresso brewing adapter before entering the container of choice selected by the user for the brewed espresso.

On the left side of FIGS. 14A-F, show a espresso brewing adapter. The brewed beverage opening of the espresso brewing adapter is shown. The opening shows the filter plurality of drainage hole when looking through the brewed beverage opening. Also shown in FIGS. 14A-F is the location where the plurality of magnets may be placed so that the controller can recognize the type of adapter inserted into the adapter chamber. A first magnet location may be located in the back left corner of the espresso brewing adapter and the magnet to be placed in the first magnet location may be affixed to remain in this location. A second magnet location may be located in the back right corner of the espresso brewing adapter and the magnet to be placed in the second magnet location may be affixed to remain in this location. For the espresso brewing adapter, a magnet may be placed in the first magnet location so that the controller recognizes that the adapter inserted into the adapter chamber is the espresso brewing adapter.

As viewed in FIGS. 15A-E, views of a hot water brewing adapter of the multiple brewing adapters that may be used with the example brewed beverage maker are visible. FIG. 15A is a top-down angled view of the of the hot water/ground coffee brewing adapter to be used with the brewed beverage maker. The hot water/ground coffee brewing adapter has a general cartridge form that is insertable into the adapter chamber as needed for operational use with the brewed beverage maker. Generally central on the cartridge form is a well that extends downward from the top surface of the cartridge form through the bottom surface of the cartridge form. In the center of the well on the hot water brewing adapter, a center post may be present. The center post raises upward about three quarters the way up the well and has a plurality of elongated openings in the downward direction. The center post prevents high pressure water outflow from the needle during the brew cycle when the hot water/ground coffee brewing adapter is used. At the base of the well where the center post raises upward, a solid ring surrounds the center post. The solid ring helps prevent remaining drip water after brewing from entering the container of the user. A filter may also surround the central post upon which coffee grounds can be placed for brewing with the hot water brewing adapter. In the front the well on the top surface of the cartridge form, a small top surface opening is present. The top surface opening here allows air into the well to prevent a negative pressure coefficient during operation of the hot water/ground coffee brewing adapter. On the front of the hot water/ground coffee brewing adapter a name plate may be present. The name plate may identify to the user the type of brewed beverage that can be made with the selected adapter when used with the brewed beverage maker.

In FIG. 15C, a bottom view of the hot water brewing adapter is visible. The brewed beverage opening of the hot water/ground coffee brewing adapter is shown. Looking up through the opening shows the solid ring used to prevent remaining drip from entering the user's container after brewing. Also shown in FIG. 15C is the location where the plurality of magnets may be placed so that the controller can recognize the type of adapter inserted into the adapter chamber. A first magnet location may be located in the back left corner of the hot water/ground coffee brewing adapter and the magnet to be placed in the first magnet location may be affixed to remain in this location. A second magnet location may be located in the back right corner of the hot water/ground coffee brewing adapter and the magnet to be placed in the second magnet location may be affixed to remain in this location. For the hot water/ground coffee brewing adapter, a magnet may be placed in both the first magnet location and the second magnet location so that the controller recognizes that the adapter inserted into the adapter chamber is the hot water/ground coffee brewing adapter.

On FIG. 15D, a back view of the hot water brewing adapter is viewed. As viewed from the back, the general cartridge form is visible moving from a front end near the name plate to the back end of hot water/ground coffee brewing adapter. The back side of the cartridge form may be flat and planer. Thus, when placed within the adapter chamber the back side of the cartridge form may be flush against the back side of the adapter chamber. In the middle of the back side of the cartridge form, a magnet may be present. The magnet may allow the hot water/ground coffee brewing adapter to magnetically connect with the magnet within the adapter chamber so that the hot water brewing adapter is snug and secure within the correct location of the adapter chamber for brewing. At the bottom of the well, is a brewed beverage opening.

FIG. 18 the control panel and user interface is shown. A plurality of LEDs and actionable buttons may be present. The part of the control panel visible to the user is formed to fit through and be present within dedicated cut outs of the front housing. The control panel may have a plurality of indicators that can be lit during operation or to notify the user of issues with operation of the brewed beverage maker. Additionally, the control panel may have a plurality of pressable buttons that can be engaged by the user to adjust the operational mode of the brewed beverage maker. As viewed in FIG. 2, the control panel may have a series of volume selections selectable by the user that may illuminate for the user to determine the volume of the brewed beverage they would like to create with the brewed beverage maker. To move through those volume selections, the user may press the power button to move the illuminated LED of the control panel to the correct volume selection for the brewed beverage. Of course, the power button is also used to first turn on operation of the brewed beverage maker and to turn off operation of the brewed beverage maker after its use by the user is complete. Below the power button an additional+sign button is present. This button allows the user to select a strong or stronger brew of the desired volume to be executed by the brewed beverage maker. The strong button may only be available with certain adapters used with the brewed beverage maker and will illuminate with the option available for user selection. Above the power button but below the series of volume options are two symbols related to the operational functionality of the brewed beverage maker. The first symbol on the left is a water droplet with a slash across the water droplet. If this LED is illuminated, the brewed beverage maker is indicating to the user that the volume of water within the water tank is low and the desired volume for a brewed beverage may not be possible. In some embodiments, illumination of the low water LED will not allow the brewed beverage maker to operate in any desired brewing mode of operation until additional water is added by the user to the water tank. Next to the low water symbol is a second symbol to its right. The symbol is a water droplet with a circular arrow surrounding the water droplet. When this symbol is illuminated, it means that descaling of the brewed beverage maker is needed. The descaling symbol is a predetermined function stored within the logic of the controller of the brewed beverage maker. After a set number of operational cycles, the descaling symbol will illuminate indicating to the user that a cleaning cycle or descaling is needed. In some embodiments, the descaling operation is an operational mode of the brewed beverage maker where the user needs to only add the necessary descaling or cleaning solution and select the mode of operation to run the descaling operation. In other embodiments, the user may simply add the descaling or cleaning solution to the brewed beverage maker and run a desired brewing operation with the use of the hot water/ground coffee adapter to clean the brewed beverage maker. Descaling is a cleaning process of appliances where water may be consistently present or evaporated to some extent that causes the buildup of minerals in the water to attach to undesirable locations or surfaces of the brewed beverage maker or other type of appliance. After descaling is complete, the LED illuminating the symbol may turn off after running the preset operation. However, in other embodiments the user may have to perform a series of input functions on the available buttons on the control panel to reset the internal descaling counter with the logic of the controller.

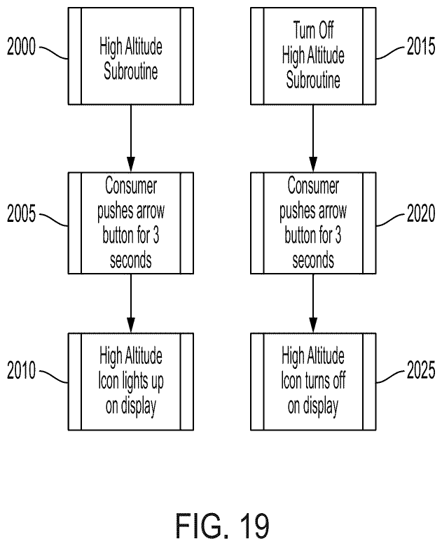

FIG. 19 illustrates a flowchart detailing high altitude operation possible with the brewed beverage maker in accordance with an embodiment of the disclosure.

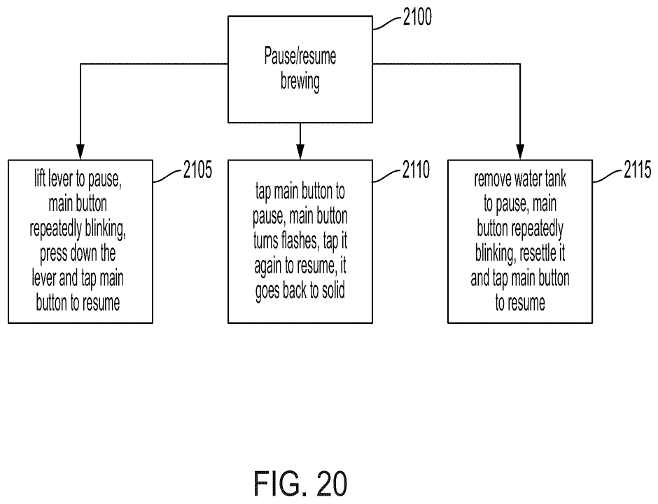

FIG. 20 illustrates a flowchart detailing a pause and a resume operation possible with the brewed beverage maker in accordance with an embodiment of the disclosure.

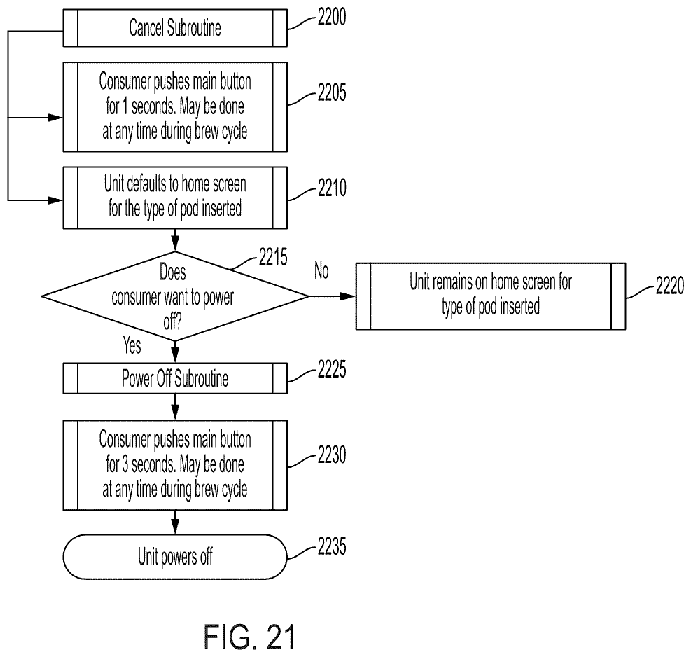

FIG. 21 illustrates a flowchart detailing a cancel operation possible with the brewed beverage maker.

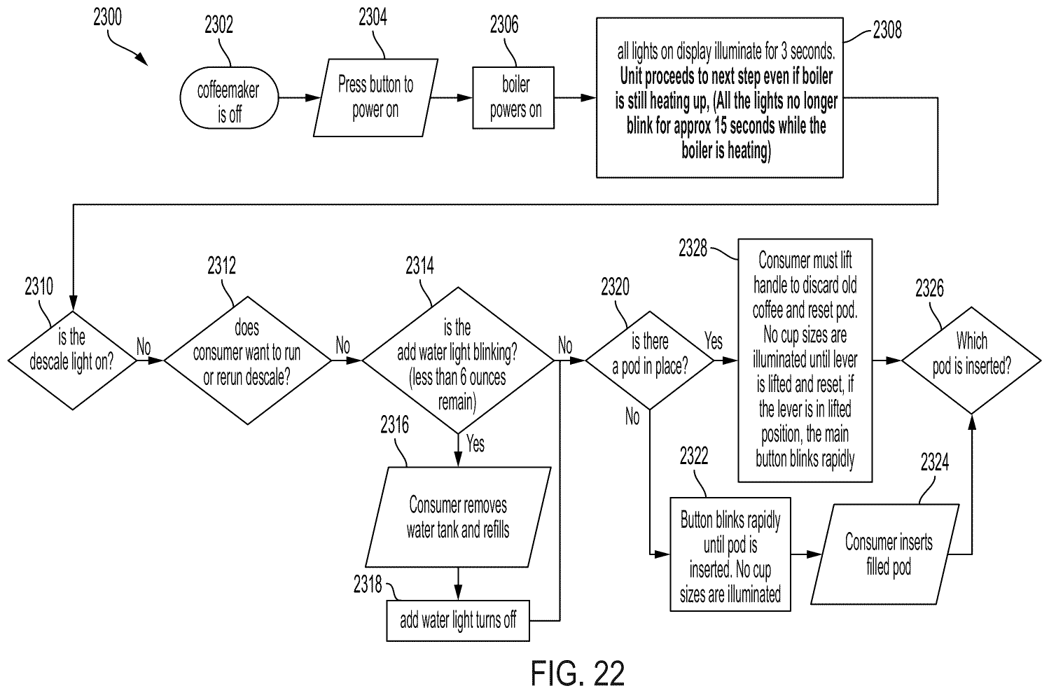

FIG. 22 illustrates a flowchart detailing a startup operation possible with the brewed beverage maker.

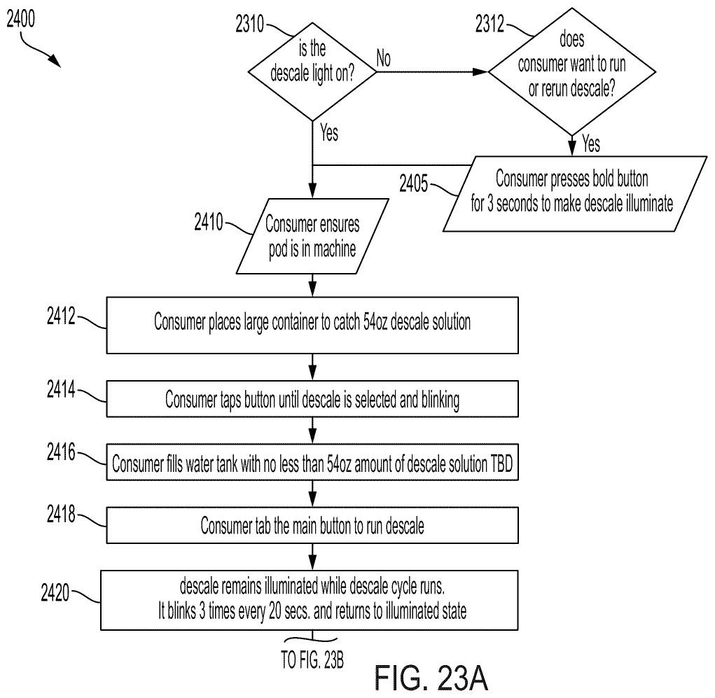

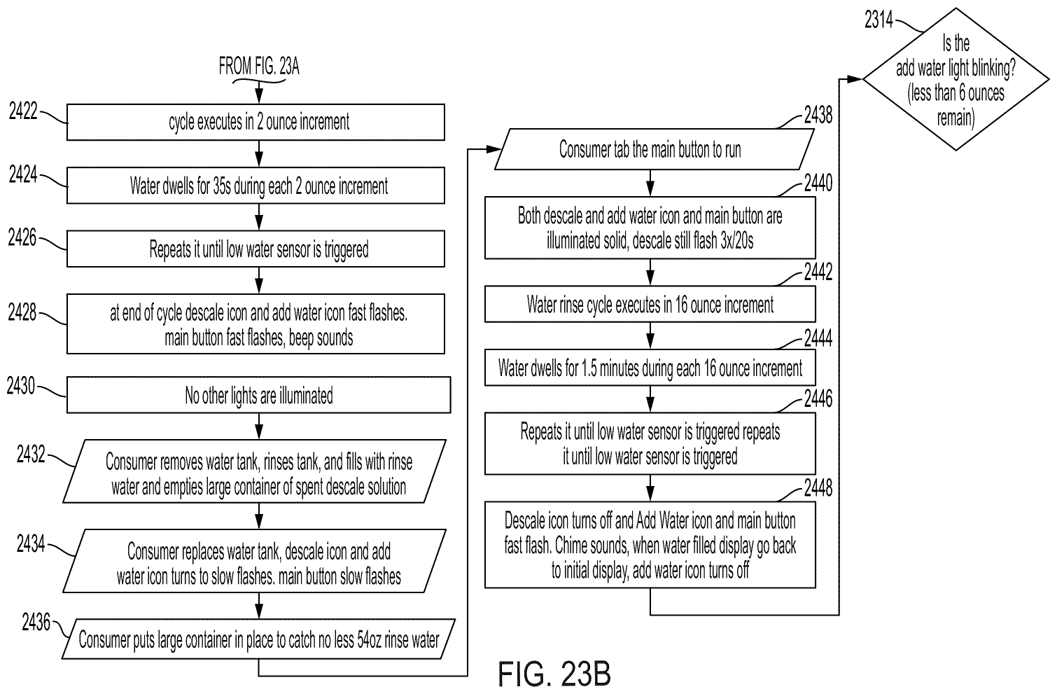

FIG. 23A-B illustrate a flowchart detailing a descaling operation possible with the brewed beverage maker.

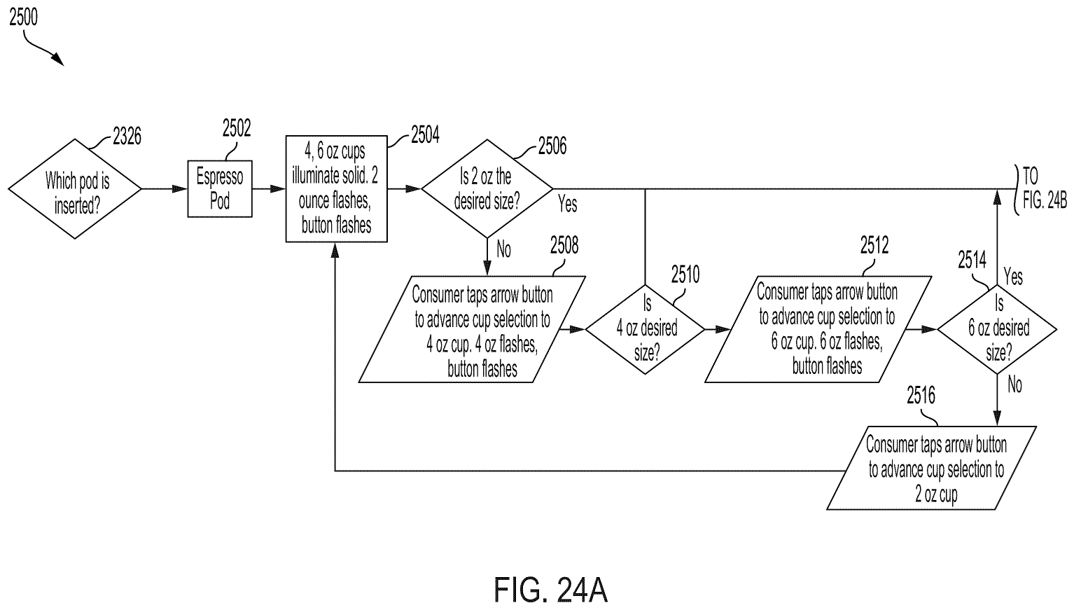

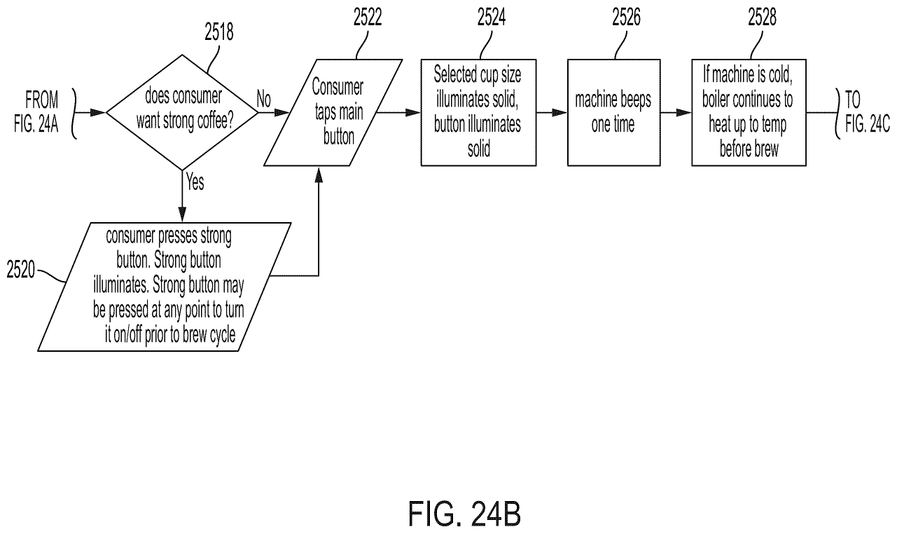

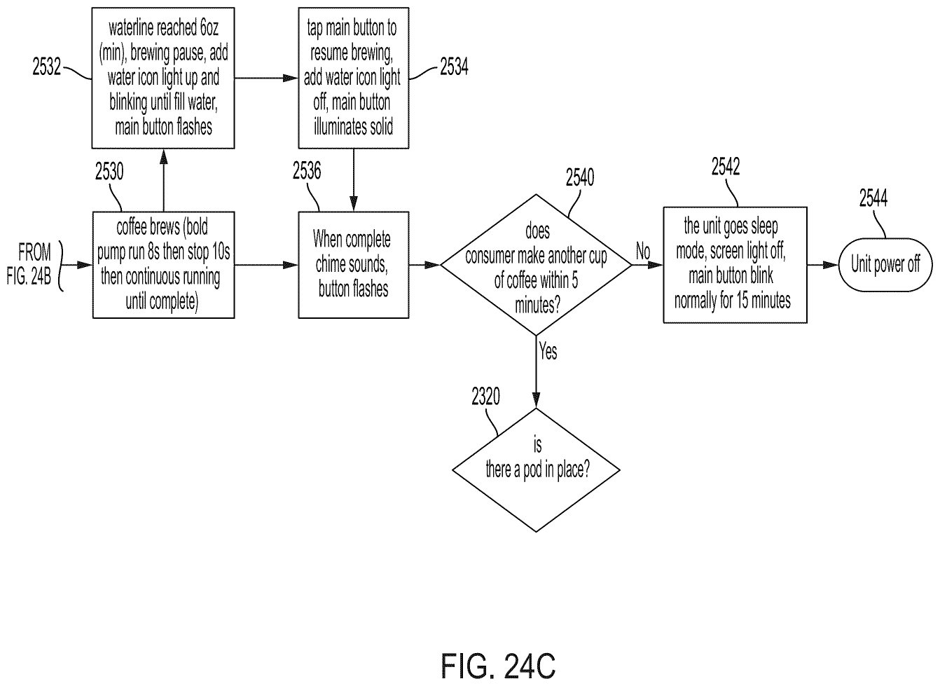

FIGS. 24A-C illustrates a flowchart detailing an example brewing operation when an espresso pod adapter is used with the brewed beverage maker to create a brewed beverage.

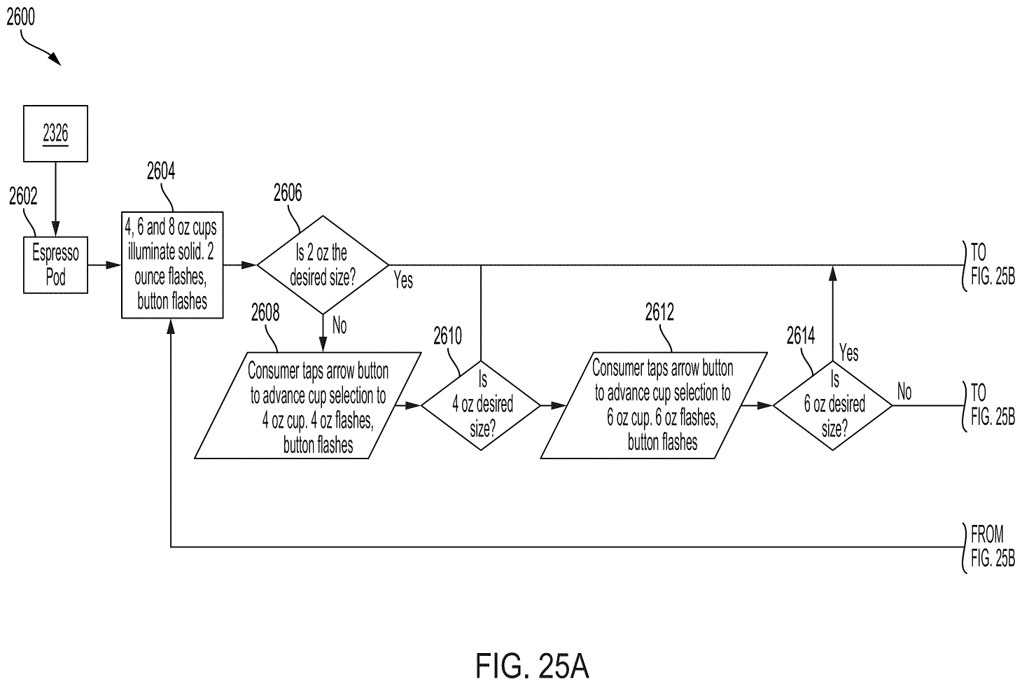

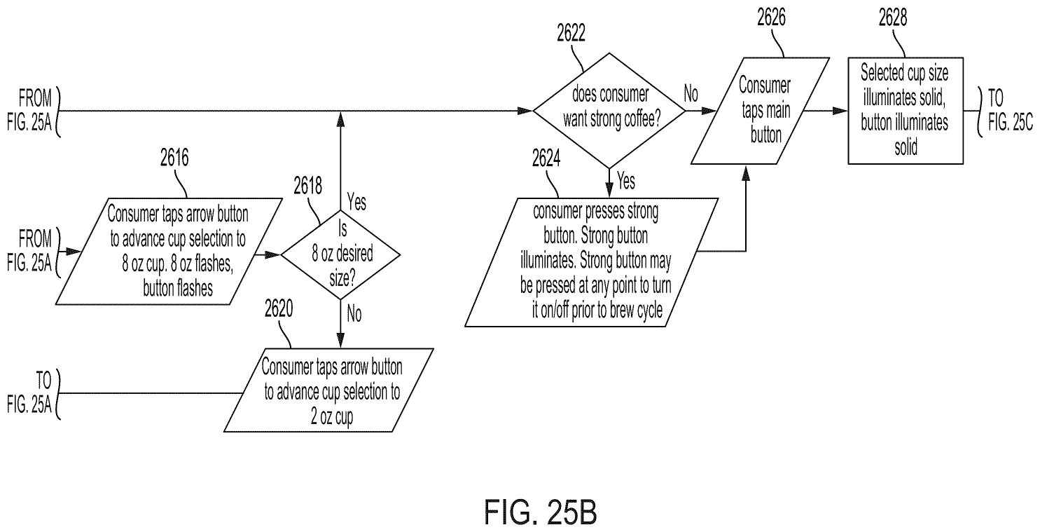

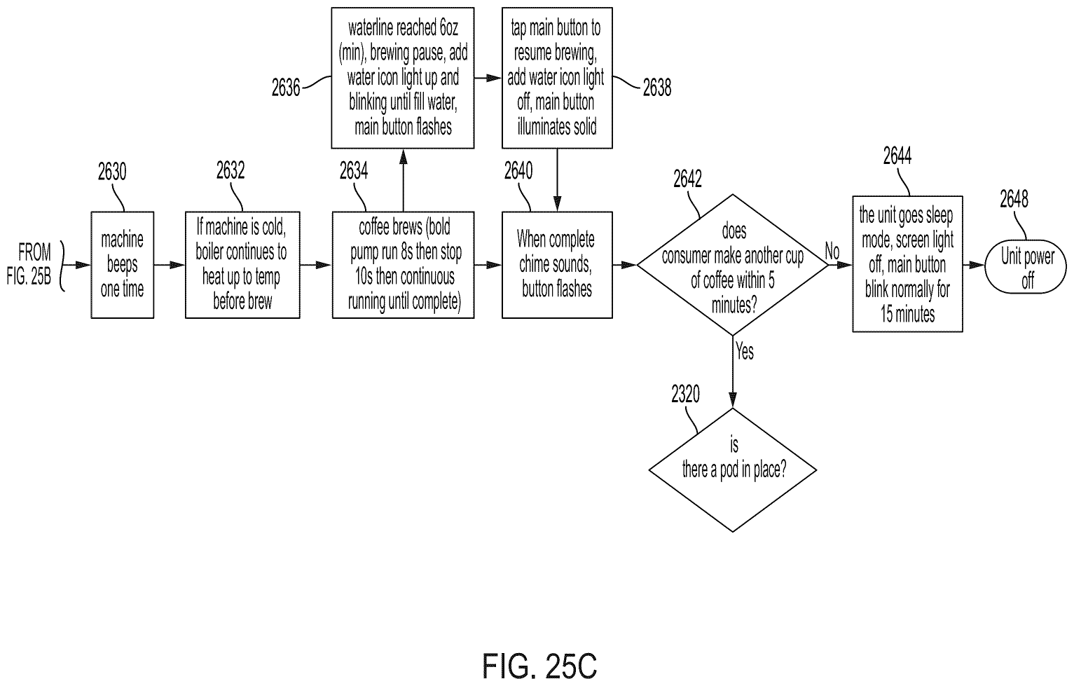

FIGS. 25A-C illustrates a flowchart detailing an example brewing operation when a ground espresso adapter is used with the brewed beverage maker to create a brewed beverage in accordance with an embodiment of the disclosure.

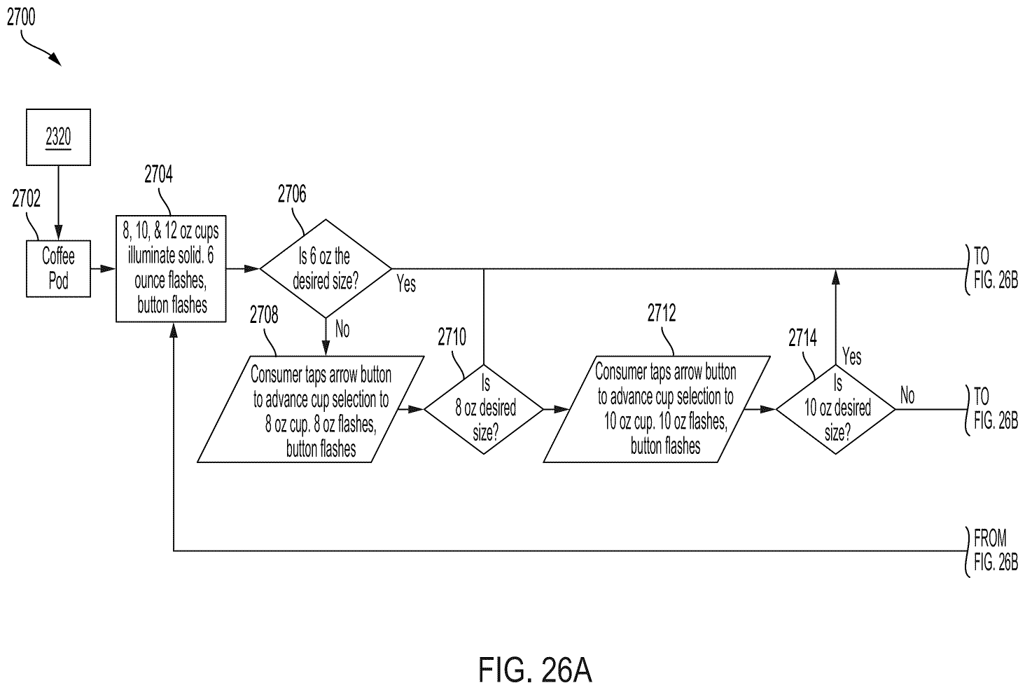

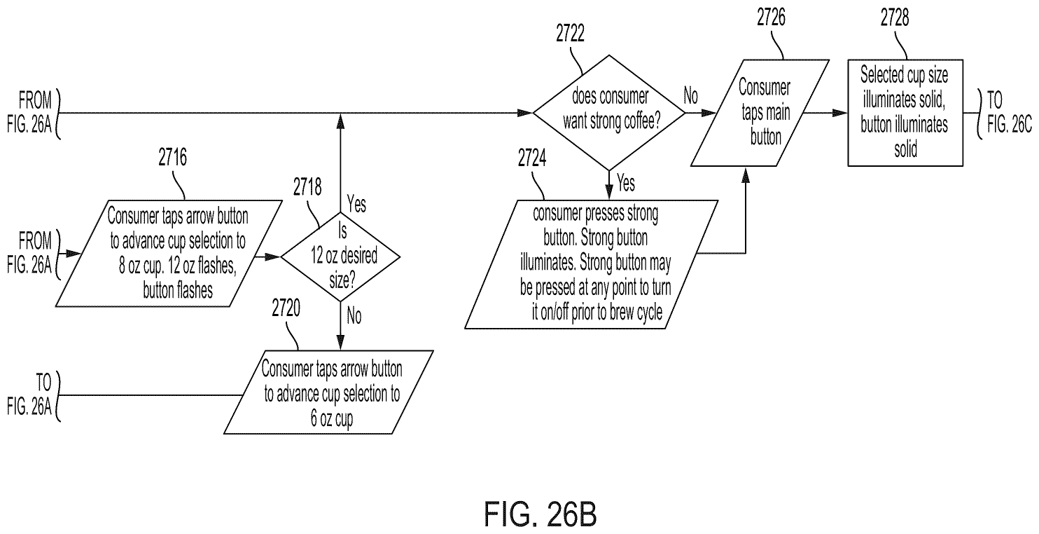

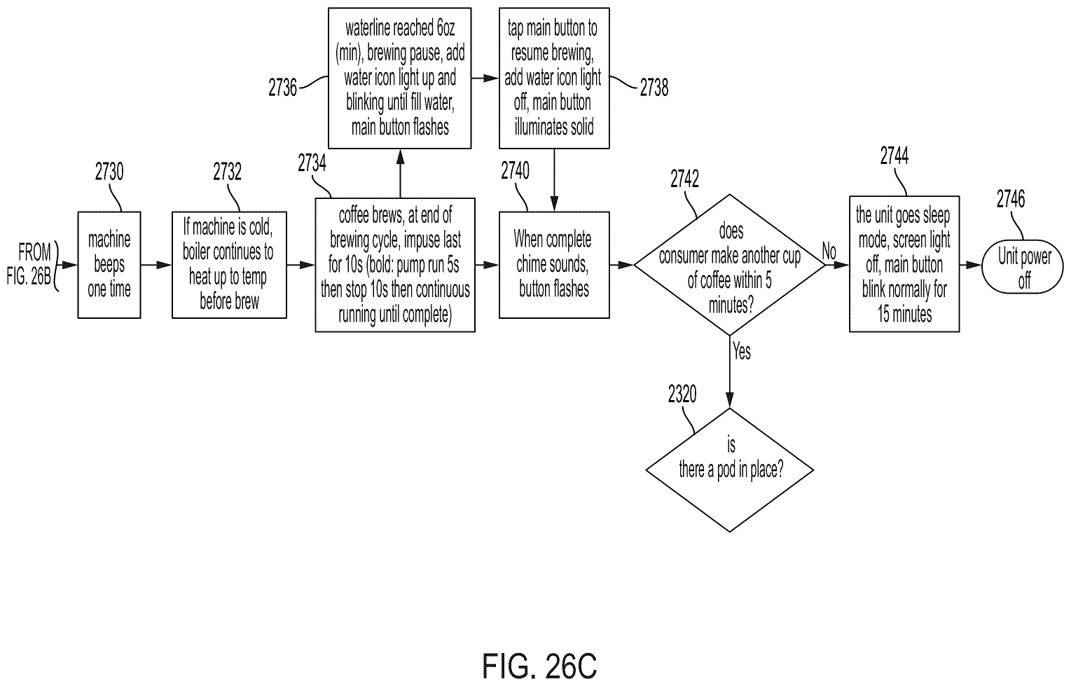

FIGS. 26A-C illustrates a flowchart detailing an example brewing operation when a coffee pod adapter is used with the brewed beverage maker to create a brewed beverage in accordance with an embodiment of the disclosure.

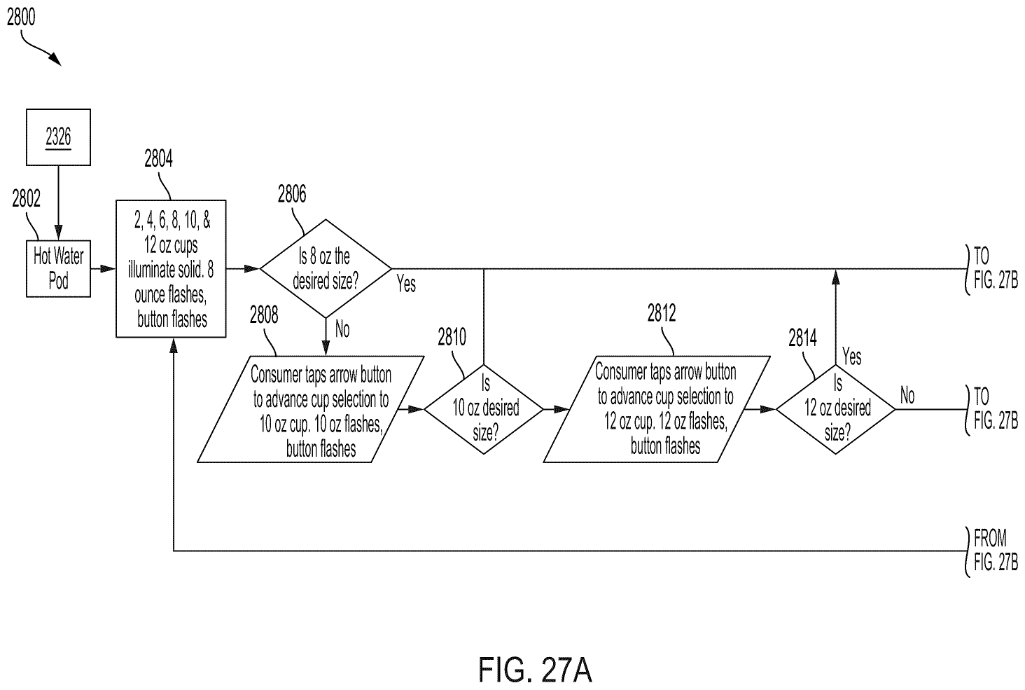

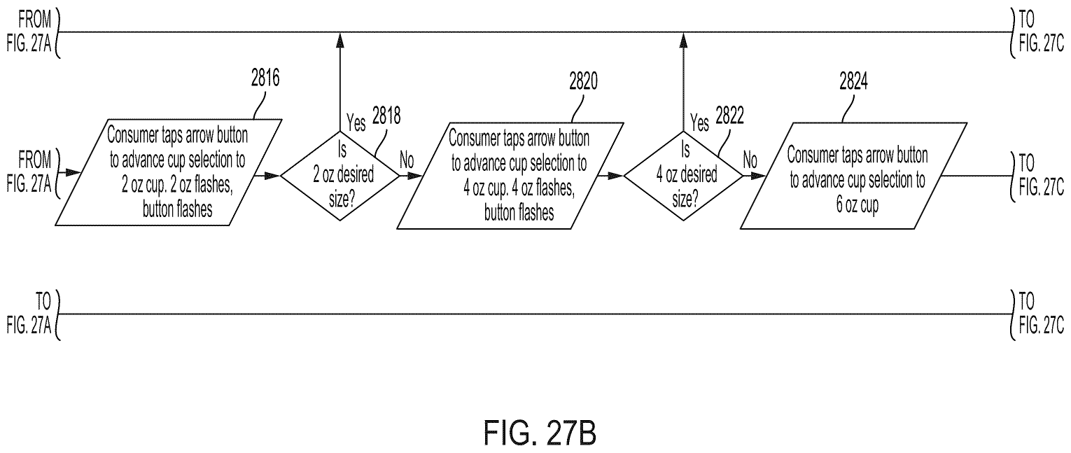

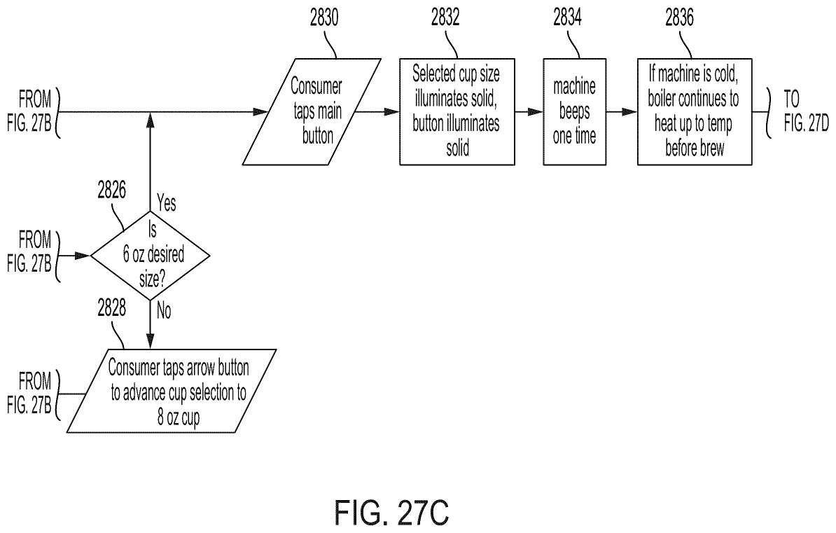

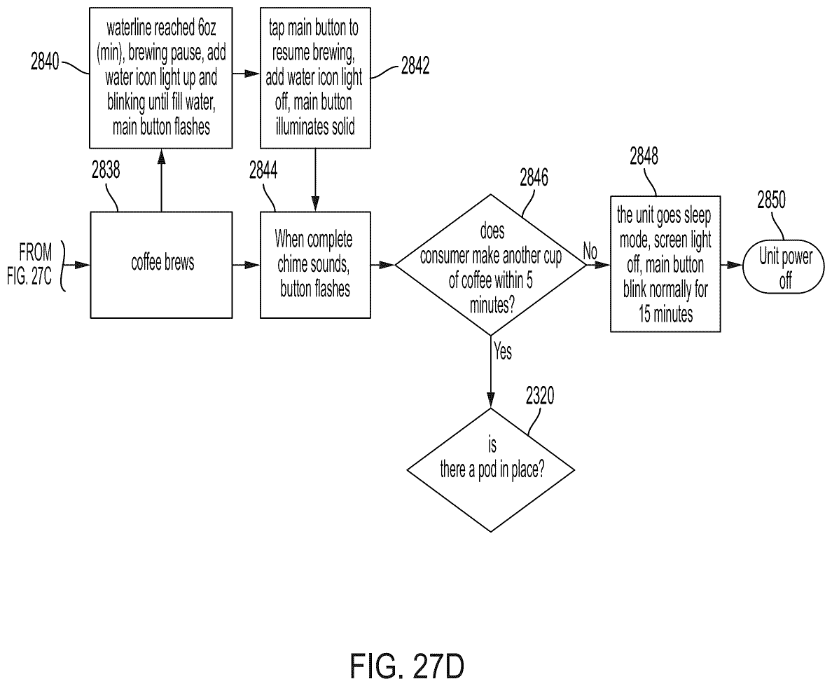

FIGS. 27A-D illustrates a flowchart detailing an example brewing operation when a hot water adapter is used with the brewed beverage maker to create a brewed beverage in accordance with an embodiment of the disclosure.

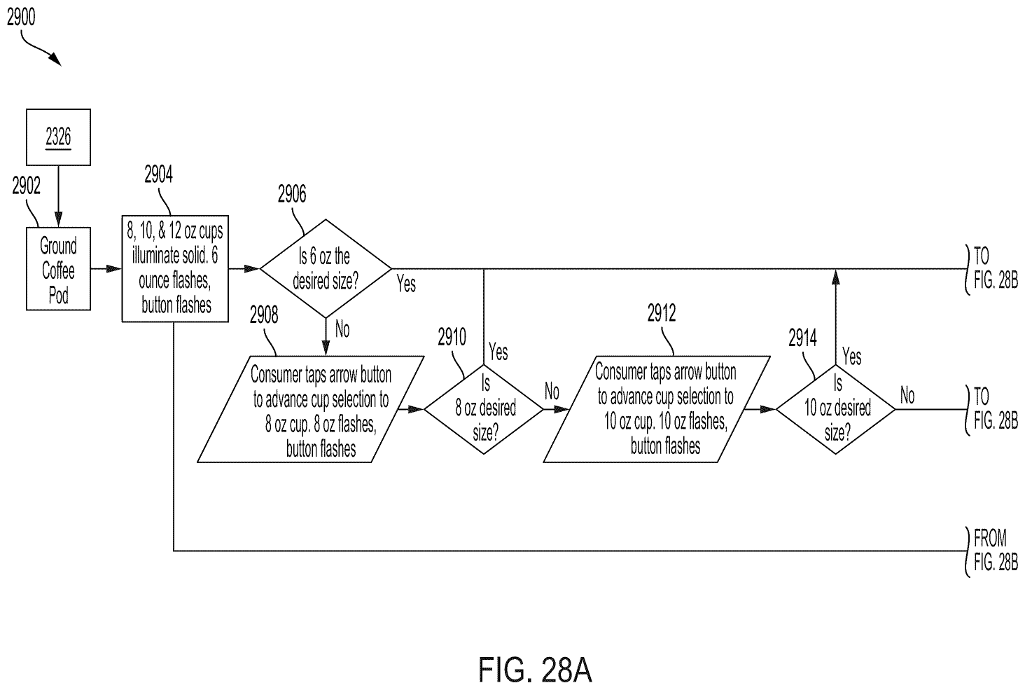

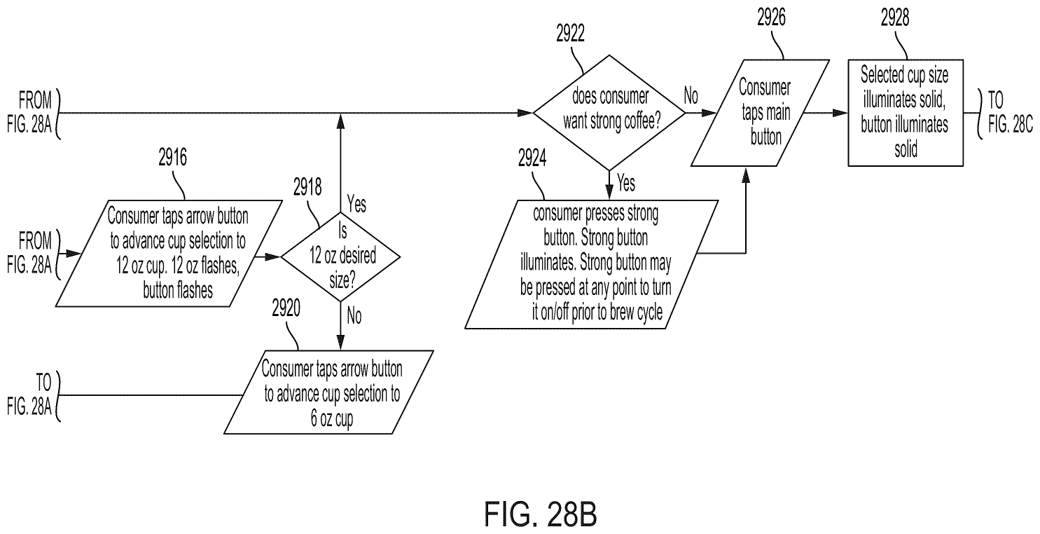

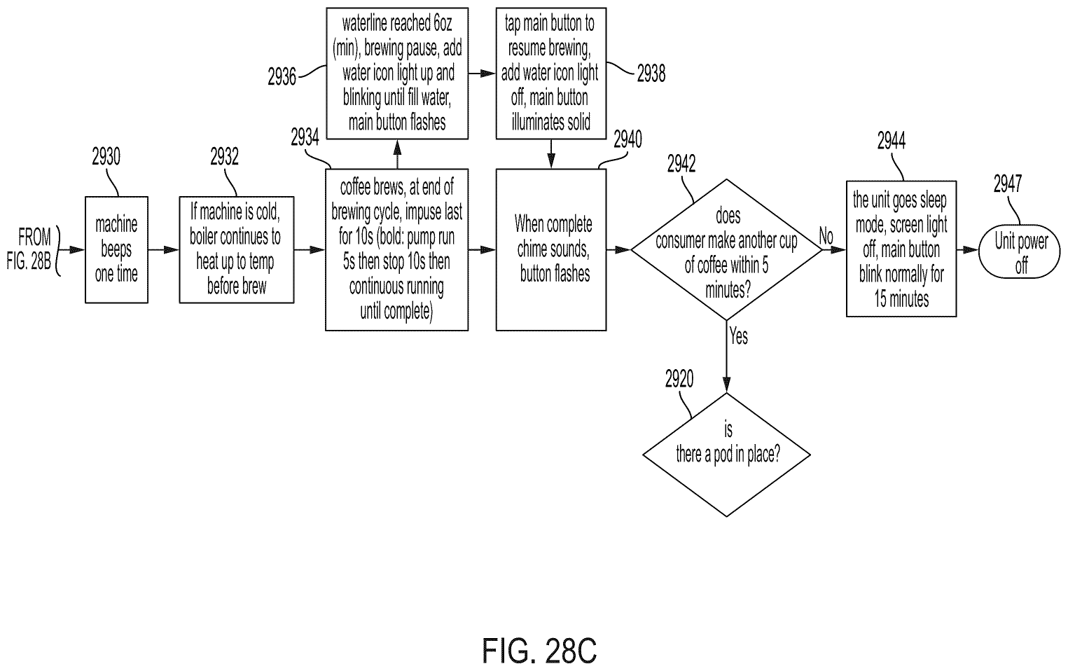

FIGS. 28A-C illustrates a flowchart detailing an example brewing operation when a ground coffee adapter is used with the brewed beverage maker to create a brewed beverage in accordance with an embodiment of the disclosure.

The embodiments were chosen and described in order to best explain the principles of the invention and its practical application to thereby enable others skilled in the art to best utilize the invention in various embodiments and with various modifications as are suited to the particular use contemplated.

As various modifications could be made in the construction and method herein described and illustrated without departing from the scope of the invention, it is intended that all matter contained in the foregoing description or shown in the accompanying drawings shall be interpreted as illustrative rather than limiting. For example, the adapters used with the brewed beverage maker, well designs for each adapter disclosed, and controller function for different envisioned brewed beverages may be employed but can achieve the same functionality of the underlying invention. Thus, the breadth and scope of the present invention should not be limited by any of the above-described example embodiments but should be defined only in accordance with the following claims appended hereto and their equivalents.

What is claimed is:

1. A brewed beverage maker comprising:
an adapter chamber, the adapter chamber formed into a housing;
an adapter having an identifier and an operational mode, the adapter removably placeable within the adapter chamber;
a controller within the housing, the controller in operational communication with a sensor;
wherein placing the adapter within the adapter chamber allows the sensor to receive the identifier of the adapter and reception of the identifier associated with the adapter sets the controller to the operational mode.

2. The brewed beverage maker of claim 1, wherein the sensor transmits the identifier to the controller to set the operational mode.

3. The brewed beverage maker of claim 1, further comprising a lever, the lever being movable from a first position and a second position.

4. The brewed beverage maker of claim 3, wherein the operational mode of the adapter allow for an action by the brewed beverage maker.

5. The brewed beverage maker of claim 4, wherein moving the level from the first position to the second position executes the action by the brewed beverage maker based on the operational mode of the adapter.

6. The brewed beverage maker of claim 1, further comprising a tab to secure the adapter within the adapter housing.

7. The brewed beverage maker of claim 6, wherein the tab is retractable between a first tab position within the housing and a second tab position within the adapter chamber.

8. The brewed beverage maker of claim 7, wherein the tab in the second tab position within the adapter chamber is placed within a recess of the adapter to secure the adapter within the adapter chamber.

9. The brewed beverage maker of claim 1, wherein the adapter is selected from a plurality of adapters.

10. The brewed beverage maker of claim 9, wherein the plurality of adapters includes at least one coffee type adapter and at least one espresso type adapter.

11. A brewed beverage maker comprising:
an adapter chamber, the adapter chamber formed into a housing;
an adapter housing located within an interior of the housing, the adapter housing able to accommodate and contain at least one adapter.
an adapter having an identifier and an operational mode, the adapter being removably placeable between the adapter chamber and the adapter housing;
a controller within the housing, the controller in operational communication with a sensor;
wherein placing the adapter within the adapter chamber allows the sensor to receive the identifier of the adapter and reception of the identifier associated with the adapter sets the controller to the operational mode.

12. The brewed beverage maker of claim 11, further comprising a lever, the lever being movable from a first position and a second position.

13. The brewed beverage maker of claim 12, wherein the operational mode of the adapter allow for an action by the brewed beverage maker.

14. The brewed beverage maker of claim 13, wherein moving the level from the first position to the second position executes the action by the brewed beverage maker based on the operational mode of the adapter.

15. The brewed beverage maker of claim 11, further comprising a tab to secure the adapter within the adapter housing.

16. The brewed beverage maker of claim 15, wherein the tab is retractable between a first tab position within the housing and a second tab position within the adapter chamber.

17. The brewed beverage maker of claim 16, wherein the tab in the second tab position within the adapter chamber is placed within a recess of the adapter to secure the adapter within the adapter chamber.

18. The brewed beverage maker of claim 11, wherein the adapter is selected from a plurality of adapters.

19. The brewed beverage maker of claim 18, wherein the adapter of the plurality of adapters is placed into the adapter chamber, and a second adapter of the plurality of adapter is placed into the adapter housing.

20. The brewed beverage maker of claim 18, wherein the plurality of adapters includes at least one coffee type adapter and at least one espresso type adapter.
